(19) United States
(12) Patent Application Publication
(10) Pub. No.: US 2025/0071789 A1
(43) Pub. Date: Feb. 27, 2025

(54) NETWORK NODE, UE AND METHODS THEREOF AND STORAGE MEDIUM

(71) Applicant: Samsung Electronics Co., Ltd., Suwon-si (KR)

(72) Inventors: Meifang JING, Beijing (CN); Weili CUI, Beijing (CN); Qing ZHU, Beijing (CN); Ying LI, Beijing (CN); Jing YUAN, Beijing (CN); Yan LI, Beijing (CN)

(21) Appl. No.: 18/676,916

(22) Filed: May 29, 2024

Related U.S. Application Data
(63) Continuation of application No. PCT/KR2024/006686, filed on May 16, 2024.

(30) Foreign Application Priority Data
Aug. 25, 2023 (CN) 202311087721.6

(51) Int. Cl. H04W 72/541; H04L 1/20; H04L 5/00

(52) U.S. Cl. CPC H04W 72/541; H04L 1/203; H04L 5/0073

(57) ABSTRACT

An example method performed by a network node may include obtaining measurement information of interference cell(s) of at least one UE and/or traffic information of the interference cell(s); adjusting a target block error rate (BLER) for a target UE in the at least one UE according to the measurement information of the interference cell(s) and/or the traffic information of the interference cell(s); and transmitting data to the target UE based on the adjusted target BLER.

### CROSS-REFERENCE TO RELATED APPLICATIONS

This application is a continuation of International Application No. PCT/KR2024/006686, designating the United States, filed on May 16, 2024, in the Korean Intellectual Property Receiving Office and claiming priority to Chinese Patent Application No. 202311087721.6 filed on Aug. 25, 2023, in the Chinese Patent Office, the disclosures of each of which are incorporated by reference herein in their entireties.

### BACKGROUND

### Field

The disclosure relates to a communication field and, for example, to a network node, a user equipment (UE), a method performed by a network node, a method performed by a UE, and a computer readable storage medium.

### Description of Related Art

In order to meet the increasing demand of wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented at higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

According to various embodiments of the present disclosure, method performed by a network node may include obtaining measurement information of interference cell(s) of at least one UE and/or traffic information of the interference cell(s); adjusting a target block error rate (BLER) for a target UE in the at least one UE according to the measurement information of the interference cell(s) and/or the traffic information of the interference cell(s); and transmitting data to the target UE based on the adjusted target BLER.

In an embodiment, the adjusting of the target block error rate (BLER) for the target UE in the at least one UE according to the measurement information of the interference cell(s) and/or the traffic information of the interference cell(s) may include determining the target UE according to the measurement information of the interference cell(s) and/or the traffic information of the interference cell(s); and adjusting the target BLER for the target UE according to measurement information and/or traffic information of interference cell(s) of the target UE.

In an embodiment, the method may include determining the at least one UE from candidate UEs according to measurement information of a serving cell of each of the candidate UEs; and transmitting, to the at least one UE, a signaling for configuring the at least one UE to perform an interference cell measurement, wherein the measurement information of the interference cell(s) of the at least one UE is obtained by the at least one UE through performing the interference cell measurement based on the signaling.

In an embodiment, the determining of the at least one UE from the candidate UEs according to the measurement information of the serving cell of each of the candidate UEs may include determining, as the at least one UE, UE(s) whose measurement information of the serving cell satisfies a predefined condition for a predefined number of slots among the candidate UEs.

In an embodiment, the determining of the target UE according to the measurement information of the interference cell(s) and/or the traffic information of the interference cell(s) may include obtaining a first classification result by classifying the interference cell(s) according to the measurement information of the interference cell(s); and obtaining a second classification result by classifying slots of the UE based on the traffic information of the interference cell(s) and the first classification result; determining the target UE based on the second classification result.

In an embodiment, the adjusting of the target block error rate (BLER) for the target UE in the at least one UE according to the measurement information of the interference cell(s) and/or the traffic information of the interference cell(s) includes at least one of: adjusting a target BLER for all slots of the target UE according to measurement information of interference cell(s) of the target UE and average traffic information on all slots of the interference cell(s) of the target UE; adjusting a target BLER for a set slot of the target UE according to the measurement information of the interference cell(s) of the target UE and traffic information on the set slot of the interference cell(s) of the target UE; or determining a target BLER adjustment method for the target UE according to the measurement information and/or traffic information of the interference cell(s) of the target UE, and adjusting the target BLER for the target UE based on the determined target BLER adjustment method.

In an embodiment, the determining of the target BLER adjustment method for the target UE according to the measurement information and/or the traffic information of the interference cell(s) of the target UE may include determining an interference intensity of the interference cell(s) of the target UE according to the measurement information of the interference cell(s) of the target UE; and determining the target BLER adjustment method for the target UE based on the interference intensity and the traffic information of the interference cell(s) of the target UE.

In an embodiment, the determining of the target BLER adjustment method for the target UE based on the interference intensity and the traffic information of the interference cell(s) of the target UE may include determining that the target BLER adjustment method for the target UE is to adjust the target BLER for all slots of the target UE if there exists, for the target UE, an interference cell that satisfies a predefined interference intensity and the traffic of the interference cell that satisfies the predefined interference intensity satisfies a predefined traffic related condition, or, if there exists, for the target UE, no interference cell that satisfies the predefined interference intensity and the traffic for interference cells of the target UE all satisfies the predefined traffic related condition; otherwise, determining that the target BLER adjustment method for the target UE is to adjust the target BLER for the set slot of the target UE.

In an embodiment, the adjusting of the target BLER for all slots of the target UE according to the measurement information of the interference cell and the average traffic information on all slots of the target UE may include predicting a target BLER for all slots of the target UE using a pre-trained artificial intelligence model according to the measurement information of the interference cell(s) of the target UE and the average traffic information on all slots of the interference cell(s) of the target UE, and adjusting the target BLER for all slots of the target UE based on the predicted target BLER; or determining a target BLER for all slots of the target UE using a pre-established mapping relationship between an interference fluctuation level and the target BLER according to the measurement information of the interference cell(s) of the target UE and the average traffic information on all slots of the interference cell(s) of the target UE, and adjusting the target BLER for all slots for the target UE based on the determined target BLER, wherein the interference fluctuation level is determined based on the average traffic information.

In an embodiment, the adjusting of the target BLER for the set slot of the target UE according to the measurement information of the interference cell(s) of the target UE and the traffic information on the set slot of the interference cell(s) of the target UE may include predicting a target BLER for the set slot of the target UE using a pre-trained artificial intelligence model according to the measurement information of the interference cell(s) of the target UE and the traffic information on the set slot of the target UE, and adjusting the target BLER for the set slot of the interference cell(s) of the target UE based on the predicted target BLER; or, determining a target BLER for the set slot of the target UE using a pre-established mapping relationship between an interference fluctuation level and the target BLER according to the measurement information of the interference cell(s) of the target UE and the traffic information on the set slot of the interference cell(s) of the target UE, and adjusting the target BLER for the set slot of the target UE based on the determined target BLER, wherein the interference fluctuation level is determined based on the traffic information on the set slot.

In an embodiment, the method may include obtaining a channel fluctuation state for the target UE; and determining whether to continue using a current target BLER according to the channel fluctuation state.

In an embodiment, the obtaining of the channel fluctuation state for the target UE may include obtaining the channel fluctuation state according to a channel difference between different slots of the target UE, wherein the channel difference between different slots of the target UE includes a difference in actual BLERs between different slots of the target UE, or a difference in signal-to-interference noise ratios (SINRs) between different slots of the target UE.

In an embodiment, the determining of whether to continue using the current target BLER according to the channel fluctuation state may include marking a channel fluctuation state acquisition period as an activate state or a deactivate state according to the channel fluctuation state; if the channel fluctuation state acquisition period is marked as the activate state, continuing using the current target BLER during the channel fluctuation state acquisition period; and if the channel fluctuation status acquisition period is marked as the deactivated state, using a default fixed target BLER during the channel fluctuation state acquisition period.

In an embodiment, the method may include performing a signal-to-interference noise ratio (SINR) compensation based on the target BLER after adjusting and the target BLER before adjusting.

In an embodiment, the performing of the SINR compensation based on the in target BLER after adjusting and the target BLER before adjusting may include determining a SINR difference between the target BLER after adjusting and the target BLER before adjusting based on a compensation factor, and compensating the SINR based on the determined SINR difference.

In an embodiment, the network node may be a base station, and the method may include receiving, from a radio access network intelligent controller (RIC), indication information indicating whether the base station is allowed to perform a target BLER adjustment; wherein the adjusting of the target block error rate (BLER) for the target UE in the at least one UE according to the measurement information of the interference cell(s) and/or the traffic information of the interference cell(s) includes: if the indication information indicates that the base station is allowed to perform the target BLER adjustment, adjusting the target BLER for the target UE based on the measurement information of the interference cell(s) and/or the traffic information of the interference cell(s).

In an embodiment, the indication information may be transmitted by the RIC based on the traffic information of the interference cell(s).

In an embodiment, the network node may be a base station, and the adjusting of the target block error rate (BLER) for the target UE in the at least one UE according to the measurement information of the interference cell(s) and/or the traffic information of the interference cell(s) may include transmitting, to a RIC, the measurement information of the interference cell of the target UE; receiving, from the RIC, a target BLER for the target UE determined by the RIC according to the measurement information and traffic information of the interference cell of the target UE; and adjusting the target BLER for the target UE based on the received target BLER.

In an embodiment, the network node may be a RIC, wherein the obtaining of the measurement information of the interference cell(s) of the at least one UE may include receiving the measurement information of the interference cell(s) of the at least one UE reported by a base station; wherein the adjusting of the target block error rate (BLER) for the target UE in the at least one UE according to the measurement information of the interference cell(s) and/or the traffic information of the interference cell(s) may include determining the target BLER for the UE according to the measurement information of the interference cell(s) and/or the traffic information of the interference cell(s), and transmitting the determined target BLER to the base station; and wherein the transmitting of the data to the target UE based on the adjusted target BLER may include controlling the base station to transmit the data to the target UE based on the determined target BLER.

In an embodiment, the controlling of the base station to transmit the data to the target UE based on the determined target BLER may include transmitting indication information to the base station based on the traffic information, wherein the indication information indicates whether the base station is allowed to perform the target BLER adjustment.

In an embodiment, the transmitting of the indication information to the base station based on the traffic information may include determining a strong interference cell among the interference cell(s), wherein the strong interference cell is a cell among the interference cell(s) that satisfies a predefined condition; determining, based on traffic information of the strong interference cell, a loading type of each slot of the strong interference cell; determining, according to the loading type of each slot of the strong interference cell, an interference type of each slot of a serving cell of the UE; and determining whether the base station is allowed to perform the target BLER adjustment based on the interference type of each slot of the serving cell, and transmitting the indication information to the base station according to a result of the determination.

In an embodiment, a method performed by a user equipment (UE) may include reporting, to a base station, measurement information of interference cell(s) of the UE; and receiving, from the base station, data transmitted based on a target block error rate (BLER) for the UE, wherein the target BLER is adjusted according to the measurement information of the interference cell(s) and/or traffic information of the interference cell(s).

In an embodiment, the method may include receiving, from the base station, a signaling for configuring the UE to perform an interference cell measurement, wherein the measurement information of the interference cell(s) is obtained by the UE through performing the interference cell measurement based on the signaling.

In an embodiment, the method may include transmitting, to the base station, measurement information of a serving cell of the UE, wherein the measurement information of the serving cell is used by the base station to determine whether to transmit the signaling to the UE.

In an embodiment, a network node may include a transceiver; a processor coupled to the transceiver and configured to perform the above method performed by the network node.

In an embodiment, the network node may include a base station or a radio access network intelligent controller (RIC).

In an embodiment, a user equipment may include a transceiver; and a processor coupled to the transceiver and configured to perform the above method performed by the user equipment.

In an embodiment, a non-transitory computer readable storage medium may store instructions that, when executed by at least one processor, cause the at least one processor to perform any one of the above methods.

According to the technical solutions provided by the various embodiments of the present disclosure, since the network node may obtain measurement information of interference cell(s) of at least one UE and/or traffic information of the interference cell(s), adjust a target block error rate (BLER) for a target UE in the at least one UE according to the measurement information of the interference cell(s) and/or the traffic information of the interference cell(s), and transmit data to the target UE based on the adjusted target BLER, the target BLER of the target UE may be adjusted adaptively, which can, for example, improve data transmission performance and user communication experience.

It should be understood that the above general descriptions and the following detailed descriptions are only illustrative and explanatory, and do not limit the present disclosure.

### BRIEF DESCRIPTION OF THE DRAWINGS

The accompanying drawings herein are incorporated into the specification and form a part of the specification, showing example embodiments in accordance with the present disclosure and used together with the specification to explain the principles of the present disclosure, but do not constitute a limitation of the present disclosure.

The above and other aspects, features and advantages of certain embodiments of the present disclosure will be more apparent from the following detailed description, taken in conjunction with the accompanying drawings, in which:

FIG. 1 illustrates an example wireless network 100 according to various embodiments of the present disclosure;

FIG. 2A and FIG. 2B illustrate an example wireless transmission path and an example wireless reception path according to various embodiments of the present disclosure;

FIG. 3A illustrates an example UE 116 according to various embodiments of the present disclosure;

FIG. 3B illustrates an example gNB 102 according to various embodiments of the present disclosure;

FIG. 4 is a schematic diagram illustrating a problem caused by having a same target BLER for all UEs;

FIG. 5 is a schematic diagram illustrating neighbor cell interference over time;

FIG. 6 illustrates a flowchart of a method performed by an example base station according to various embodiments of the present disclosure;

FIG. 7 is a schematic diagram illustrating determining a candidate UE according to various embodiments of the present disclosure;

FIG. 8 is a schematic diagram illustrating a classification result for a strong interference neighbor cell;

FIG. 9 is a schematic diagram illustrating a classification process for a strong interference neighbor cell;

FIG. 10 is a schematic diagram illustrating a relationship between a neighbor cell traffic and an interference fluctuation;

FIGS. 11A and 11B are schematic diagrams illustrating a classification effect of a neighbor cell traffic of a slot index;

FIG. 12 is a schematic diagram illustrating determining a target BLER based on an output of an AI model;

FIG. 13 is a schematic diagram illustrating an example of an AI model according to various embodiments of the present disclosure;

FIG. 14 is an example of a mapping relationship table of a predefined neighbor cell traffic, an interference fluctuation level, and a target BLER, according to various embodiments of the present disclosure;

FIGS. 15A and 15B are schematic diagrams illustrating an example of determining a target BLER according to various embodiments of the present disclosure;

FIGS. 16A and 16B are schematic diagrams illustrating a state switching of a channel fluctuation state checking period according to various embodiments of the present disclosure;

FIG. 17 is a schematic diagram illustrating SINR compensation according to various embodiments of the present disclosure;

FIG. 18 is a schematic diagram illustrating determining a loading type for each slot index of a strong interference cell according to various embodiments of the present disclosure;

FIG. 19 is a schematic illustrating determining a cell-level target BLER adaptive switch according to various embodiments of the present disclosure;

FIG. 20 is a flowchart illustrating a method performed by an example UE according to various embodiments of the present disclosure;

FIG. 21 is a schematic diagram illustrating a scheme for realizing a target BLER adjustment according to various embodiments of the present disclosure;

FIG. 22 is a schematic diagram illustrating determining a target UE according to various embodiments of the present disclosure;

FIG. 23 is a schematic diagram illustrating determining a target BLER adjustment method according to various embodiments of the present disclosure;

FIG. 24 is a schematic diagram illustrating performing channel state self-checking according to various embodiments of the present disclosure;

FIG. 25 is a schematic diagram illustrating another scheme for realizing target BLER adjustment according to various embodiments of the present disclosure;

FIG. 26 is a diagram illustrating an example deployment scheme for realizing the concept of the present disclosure;

FIG. 27 illustrates a block diagram of an example network node according to various embodiments of the present disclosure;

FIG. 28 illustrates a block diagram of an example user equipment according to various embodiments of the present disclosure; and

FIG. 29 is a schematic diagram illustrating a structure of an example electronic device according to various embodiments of the present disclosure.

The same reference numerals are used to represent the same elements throughout the drawings.

### DETAILED DESCRIPTION

The description is provided below with reference to the accompanying drawings to facilitate comprehensive understanding of various example embodiments of the present disclosure as defined by the claims and the equivalents thereof. This description includes various specific details to help with understanding but should only be considered illustrative. Consequently, those ordinarily skilled in the art will realize that various example embodiments described here can be varied and modified without departing from the scope and spirit of the present disclosure. In addition, the description of function and structure of the common knowledge may be omitted for clarity and conciseness.

The terms and expressions used in the claims and the description below are not limited to their lexicographical meaning but may be used by the inventor to enable a clear and consistent understanding of the present disclosure. Therefore, it should be apparent to those skilled in the art that the following description of the various embodiments of the present disclosure is provided only for the purpose of the illustration without limiting the present disclosure as defined by the appended claims and their equivalents.

It will be understood that, unless specifically stated, the singular forms “one”, “a”, and “said” used herein may also include the plural form. Thus, for example, “component surface” refers to one or more such surfaces. When one element is “connected” or “coupled” to another element, the one element may be directly connected or coupled to the another element, or it may mean that a connection relationship between the one element and the another element is established through an intermediate element. In addition, “connect” or “couple” used herein may include a wireless connection or wireless coupling.

The terms “includes” and “may include” refer to, for example, the presentation of the corresponding disclosed functions, operations, or components that can be used in various embodiments of the present disclosure, but do not limit the presentation of one or more additional functions, operations, or features. In addition, it should be understood that the terms “including” or “having” may be interpreted to refer to, for example, certain features, numbers, steps, operations, components, assemblies or combinations thereof, but should not be interpreted to exclude the possibility of the existence of one or more of other features, numbers, steps, operations, components, assemblies and/or combinations thereof.

The term “or” used in various embodiments of the disclosure herein includes any listed term and all combinations thereof. For example, “A or B” may include A, or include B, or include both A and B. When a plurality of (two or more) items are described, if a relationship between the plurality of items is not clearly defined, “between the plurality of items” may refer to one, some, or all of the plurality of items. For example, for a description “a parameter A includes A1, A2, A3”, it may be implemented that the parameter A includes A1, or A2, or A3, and it may also be implemented that the parameter A includes at least two of the three parameters A1, A2, A3.

Unless defined differently, all terms as used in the present disclosure (including technical or scientific terms) have the same meanings as understood by those skilled in the art as described in the present disclosure. As common terms defined in dictionaries are interpreted to have meanings consistent with those in the context in the relevant technical field, and they should not be idealized or overly formalized unless expressly defined as such in the present disclosure.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜ module’, ‘˜ unit’, ‘˜ part’, ‘˜ body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

At least some of the functions in the device or electronic apparatus provided in the embodiments of the disclosure may be implemented through an AI model, for example, at least one module among a plurality of modules of the device or electronic apparatus may be implemented through the AI model. Functions associated with AI may be performed by a non-volatile memory, a volatile memory, and processors.

A processor may include one or more processors. The processor may include various processing circuitry (e.g., logic circuits and arithmetic circuits) and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. At this time, the one or more processors may be a general-purpose processor, such as a central processing unit (CPU), an application processor (AP), etc., or a processor used only for graphics, such as, a graphics processing unit (GPU), a visual processing unit (VPU), and/or an AI dedicated processor (such as, a neural processing unit (NPU).

The one or more processors may control the processing of input data according to predefined operation rules or AI models stored in a non-volatile memory and a volatile memory. The predefined operation rules or AI models may be provided through training or learning.

Here, providing by learning means that predefined operation rules or AI models with desired characteristics may be obtained by applying a learning algorithm to a plurality of learning data. The learning may be performed in the device or the electronic apparatus itself executing AI according to the embodiment, and/or may be implemented by a separate server/system.

The AI models may include a plurality of neural network layers. Each layer includes a plurality of weight values, and performs a neural network calculation by performing a calculation between the input data of this layer (for example, the calculation results of the previous layer and/or the input data of the AI model) and the plurality of weight values of the current layer. Examples of the neural network include, but are not limited to, a convolution neural network (CNN), a depth neural network (DNN), a recurrent neural network (RNN), a restricted Boltzmann machine (RBM), a depth confidence network (DBN), a bidirectional recursive depth neural network (BRDNN), a generative countermeasure network (GAN), and a depth Q network.

A learning algorithm refers to, for example, a method that uses a plurality of learning data to train a predetermined target apparatus (for example, a robot) to enable, allow, or control the target apparatus to make a determination or prediction. Examples of the learning algorithm include, but are not limited to, supervised learning, unsupervised learning, semi supervised learning, or reinforcement learning

According to the present disclosure, at least one step of a method performed by a network node or a user equipment, such as (but not limited to) a step of determining a target block error rate (BLER), may be implemented using an artificial intelligence model. The processor of the electronic apparatus may perform preprocessing operations on data to convert it into a form suitable for use as input to artificial intelligence models. The artificial intelligence models may be obtained through training. Here, “obtained through training” refers to, for example, training a basic artificial intelligence model with a plurality of training data through a training algorithm to obtain the predefined operation rules or artificial intelligence models, which are configured to perform the required features (or purposes).

Below, the technical solutions of the embodiments of the disclosure and the technical effects produced by the technical solutions of the disclosure will be explained by describing several example embodiments. It should be pointed out that the following implementations can be mutually referenced, drawn, or combined, and for the same terms, similar features, and similar implementation steps in different implementations, they will not be repeated.

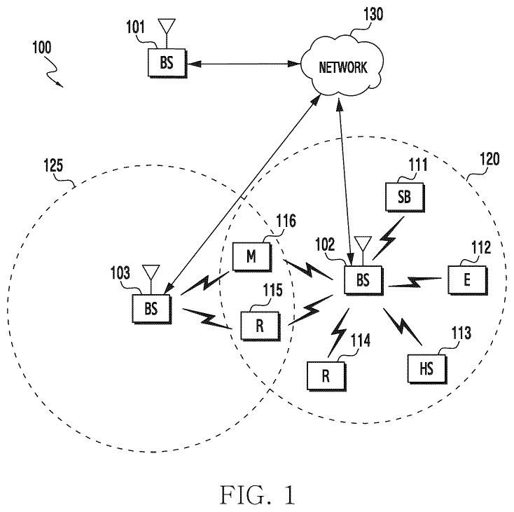

FIG. 1 illustrates an example wireless network 100 according to various embodiments of the present disclosure. The embodiment of the wireless network 100 shown in FIG. 1 is for illustration only. Other embodiments of the wireless network 100 may be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” may be used instead of “gNodeB” or “gNB”. For convenience, the terms “gNodeB” and “gNB” are used in this disclosure to refer to network infrastructure components that provide wireless access for remote terminals. And, depending on the type of the network, other well-known terms such as “mobile station”, “user station”, “remote terminal”, “wireless terminal” or “user apparatus” may be used instead of “user equipment” or “UE”. For convenience, the terms “user equipment” and “UE” are used in this disclosure to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); and a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include UE 115 and UE 116. In various embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in various embodiments of the present disclosure. In various embodiments, one or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102 and 103 can directly communicate with the network 130 and provide direct wireless broadband access to the network 130 for the UEs. In addition, gNB 101, 102 and/or 103 can provide access to other or additional external networks, such as external telephone networks or other types of data networks.

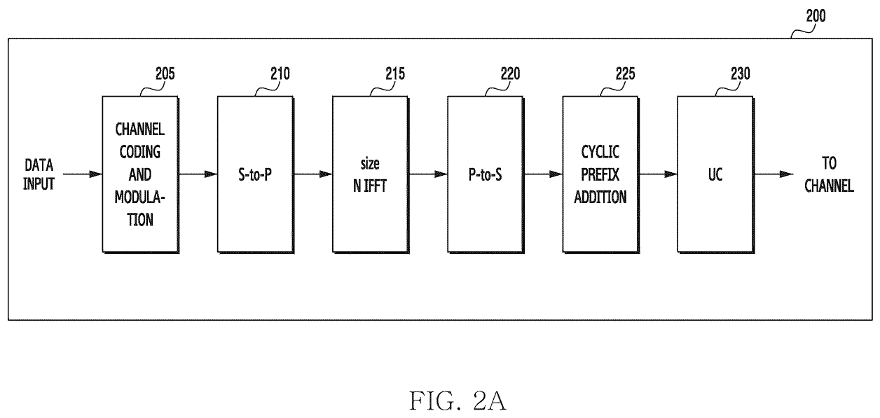

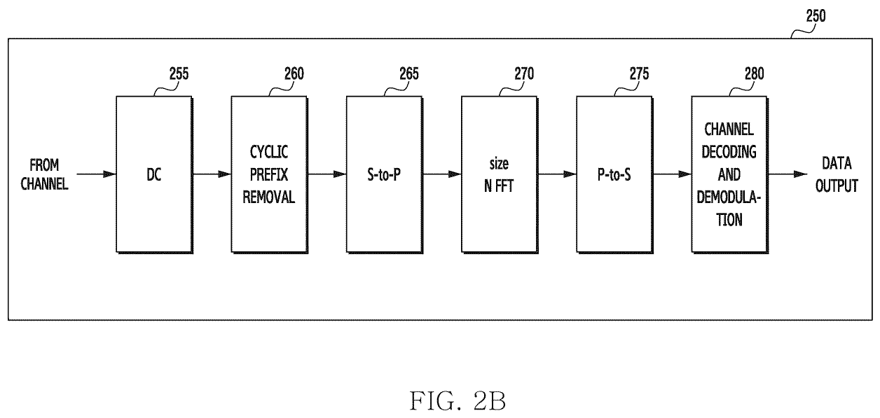

FIGS. 2A and 2B illustrate example wireless transmission and reception paths according to various embodiments of the present disclosure. In the following description, the transmission path 200 may be described as being implemented in a gNB, such as gNB 102, and the reception path 250 may be described as being implemented in a UE, such as UE 116. However, it should be understood that the reception path 250 may be implemented in a gNB and the transmission path 200 may be implemented in a UE. In various embodiments, the reception path 250 is configured to support codebook designs and structures for systems with 2D antenna arrays as described in various embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency domain modulated symbols. The Serial-to-Parallel (S-to-P) block 210 converts (e.g., demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (e.g., multiplexes) parallel time domain output symbols from the Size N IFFT block 215 to generate a serial time domain signal. The cyclic prefix addition block 225 inserts a cyclic prefix into the time domain signal. The up-converter 230 modulates (e.g., up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency domain signals. The Parallel-to-Serial block 275 converts the parallel frequency domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B may be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms may be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B may be combined, further subdivided or omitted, and additional components may be added according to specific requirements. Furthermore, FIGS. 2A and 2B are intended to illustrate examples of types of transmission and reception paths that may be used in a wireless network. Any other suitable architecture may be used to support wireless communication in a wireless network.

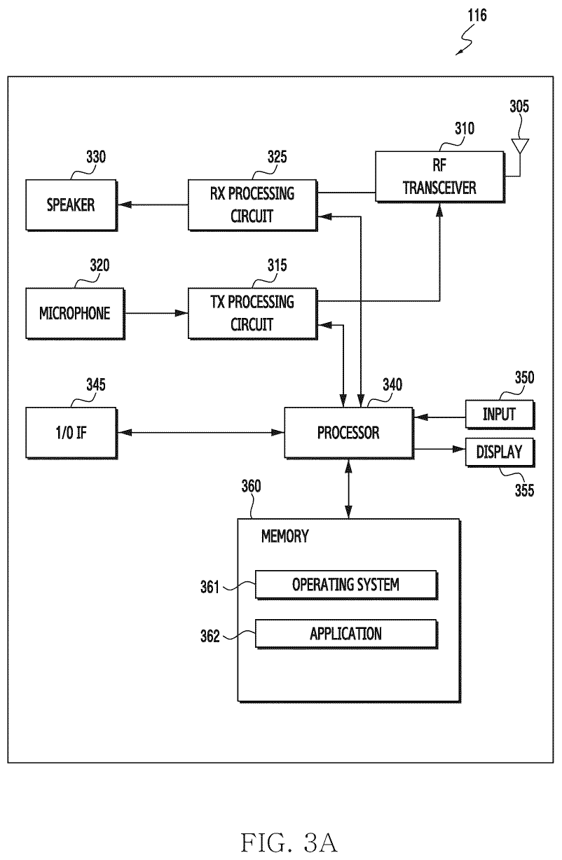

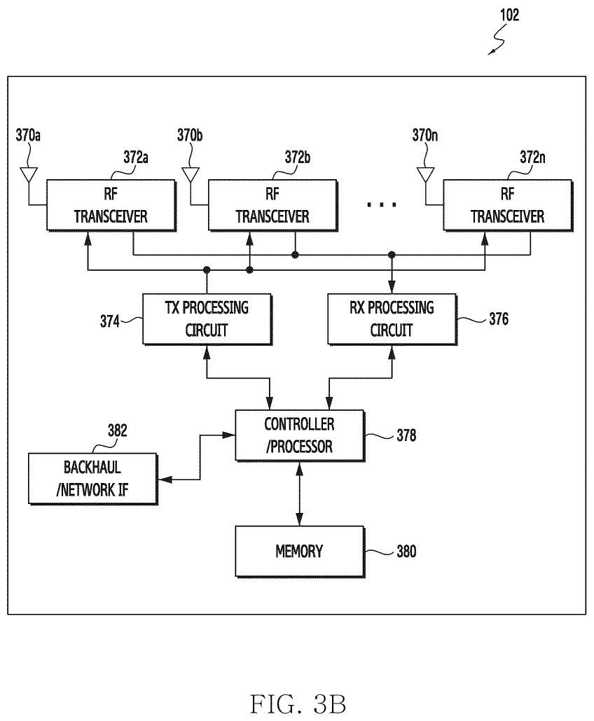

FIG. 3A illustrates an example UE 116 according to various embodiments of the present disclosure. The embodiment of UE 116 shown in FIG. 3A is for illustration only, and UEs 111-115 of FIG. 1 can have the same or similar configuration. However, a UE may have various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In various embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in various embodiments of the present disclosure. The processor/controller 340 can move data into or out of the memory 360 as required by an execution process. In various embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes may be made to FIG. 3A. For example, various components in FIG. 3A may be combined, further subdivided or omitted, and additional components may be added according to specific requirements. As a specific example, the processor/controller 340 may be divided into a plurality of processors, such as one or more central processing units (CPUs) and one or more graphics processing units (GPUs). Furthermore, although FIG. 3A illustrates that the UE 116 is configured as a mobile phone or a smart phone, UEs may be configured to operate as other types of mobile or fixed devices.

FIG. 3B illustrates an example gNB 102 according to various embodiments of the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In various embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-layer wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In various embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in various embodiments of the present disclosure. In various embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In various embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3B. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In data transmission schemes of existing communication systems, data is always transmitted based on a fixed target Block Error Rate (BLER), e.g., a user's modulation coding scheme is always determined based on the fixed target BLER, and data is transmitted in accordance with the determined modulation coding scheme. However, if a fixed target BLER is always the same for all UEs within a cell or the same fixed target BLER is used at any time, it cannot match different UEs or different neighbor cell interference degrees to which the UE is subjected at different times, which can lead to degraded transmission performance (e.g., reduced data transmission rate, low throughput) and a poor communication experience for the user. For example, in the small packet centralized scheduling scheme in the 5G communication system, the transmission slot of the small packet may be reduced through the small packet centralized scheduling to improve the system throughput and the energy consumption of the network. But the small packet centralized scheduling may lead to large differences in the neighbor cell interference on the different slots, which makes the interference fluctuations of different UEs different. The interference fluctuations may change over time, in which case, if a fixed target BLER is always used, it will lead to degradation of the transmission performance and the poor communication experience of the user.

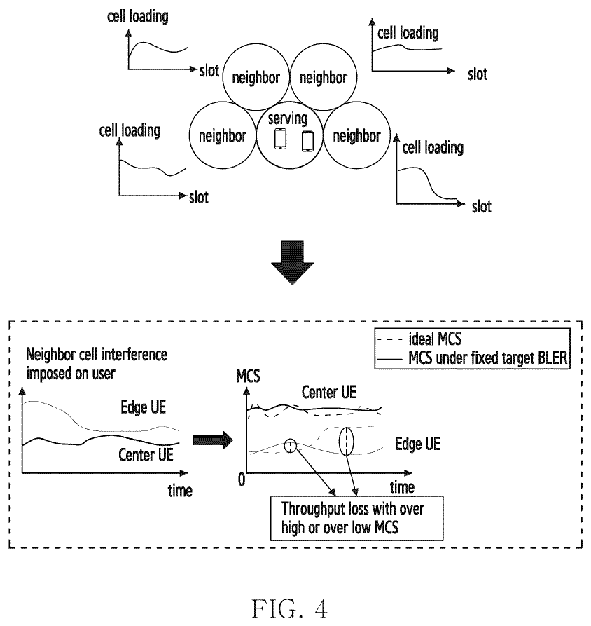

FIG. 4 is a schematic diagram illustrating a problem caused by having the same target BLER for all UEs. As shown in FIG. 4, due to different cell loads in the neighbor cells of different UEs, the neighbor cell interference on different UEs is different. For a UE with different neighbor cell interference, a link adaptation scheme may be unable to adapt to interference situations of different UEs if the same target BLER is used, thereby reducing the throughput of the UE. For example, for an edge user (e.g., an edge UE) in a serving cell, a fixed target BLER will result in a mismatch between a determined modulation coding scheme and an actual channel state (e.g., a modulation coding level is too low or too high). However, adopting a modulation coding scheme that is too high or too low compared to an ideal modulation coding scheme results in a loss of throughput.

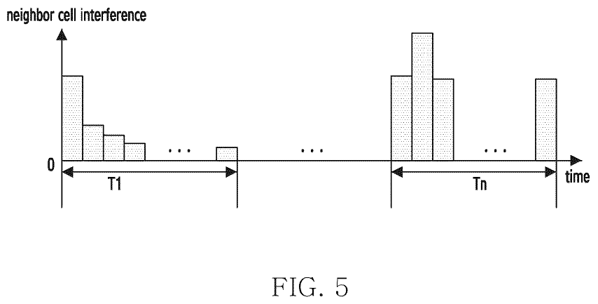

FIG. 5 is a schematic diagram illustrating neighbor cell interference variations over time. As shown in FIG. 5, the neighbor cell interference to which the same UE is subjected varies over time. However, if the same fixed target BLER is used at all times, the target BLER, which is always constant, cannot adapt to the time-varying interference, which can degrade the user's communication experience.

In view of this, the present disclosure proposes various technical solutions capable of adaptively adjusting a target BLER for a UE, which can, for example, effectively improve data transmission performance and user communication experience.

In the following, various embodiments according to the present disclosure will be described in detail.

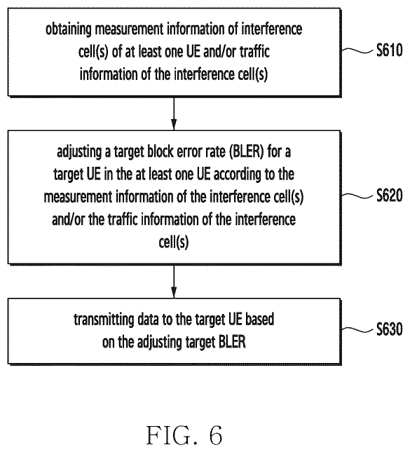

FIG. 6 illustrates a flowchart of a method performed by an example network node according to various embodiments of the present disclosure.

Referring to FIG. 6, at step S610, measurement information of interference cell(s) of at least one UE and/or traffic information of the interference cell(s) is obtained. According to embodiments, the network node may include, for example, a base station, a Radio Access Network Intelligent Controller (RIC) or other network node. For example, if the network node is a base station, the obtaining of the measurement information of the interference cell(s) of the at least one UE in step S610 may include the base station receiving the measurement information of the interference cell(s) of the at least one UE reported by the at least one UE, and the obtaining of the traffic information of the interference cell(s) in step S610 may include the base station obtaining the traffic information of the interference cell(s) through an interface interaction between base stations or an interface interaction between a RIC and the base station The obtaining of the traffic information of the interference cell(s) by the base station is not limited to the above methods, and the traffic information may also be received by the base station from other devices. If the network node is a RIC, the obtaining of the measurement information of the interference cell(s) of the at least one UE in step S610 may include the RIC receiving the measurement information of the interference cell(s) received by the base station from the at least one UE as reported by the base station, and the obtaining of the traffic information of the interference cell(s) in step S610 may include the RIC obtaining the traffic information as reported by the interference cell from the interference cell. According to various embodiments, one RIC may manage a plurality of base stations, each of which may obtain the traffic information of the interference cell of the UE, e.g., traffic information of a neighboring cell of the UE, through an interface interaction between it and the RIC. Furthermore, as an example, the aforementioned traffic information may be traffic information obtained based on statistics of historical traffic, or traffic information obtained based on a prediction of an artificial intelligence model. For example, the traffic information may include Physical Resource Block (PRB) loading information.

Here, the at least one UE may be candidate UE(s), i.e., UE(s) whose target BLER may need to be adjusted. According to embodiments, all UEs may be candidate UEs by default, or at least one UE may be determined from all UEs as final candidate UE(s) according to a certain manner. If the at least one UE is determined from all UEs as the final candidate UE(s), the method illustrated in FIG. 6 may also include determining the at least one UE from candidate UEs according to measurement information of a serving cell of each of the candidate UEs; and transmitting, to the at least one UE, a signaling for configuring the at least one UE to perform an interference cell measurement, wherein the measurement information of the interference cell(s) of the at least one UE is obtained by the at least one UE through performing the interference cell measurement based on the signaling. For example, if the network node is a base station, whether a UE is a candidate UE may be determined based on the measurement information of the service cell reported by the UE. If the UE is determined to be a candidate UE, the base station may configure the UE to perform the interference cell measurement such that the candidate UE may report its measurement information of the interference cell. If the network node is a RIC, the RIC may determine whether the UE is a candidate UE based on the measurement information of the service cell reported by the UE obtained from the base station, and, if it is a candidate UE, control the base station to transmit the signaling to the candidate UE for configuring it to perform the interference cell measurement.

In the present disclosure, the interference cell of the UE may be any cell that causes interference to the UE, e.g., the interference cell of the UE may be a neighboring cell of the UE, or a cell that is not a neighboring cell of the UE but causes interference to the UE.

For example, both the measurement information of the interference cell and the measurement information of the serving cell may be at least one of Synchronization Signal Reference Signal Received Power (SS-RSRP), Reference Signal Received Power (RSRP), Channel Quality Indicator (CQI), Rank Indication (RI), or Precoding Matrix Indicator (PMI), but is not limited to these. As an example, the base station may determine a candidate user based on the SS-RSRP of the service cell reported by the UE, and transmit to the candidate user a signaling for configuring it to perform the interference cell measurement.

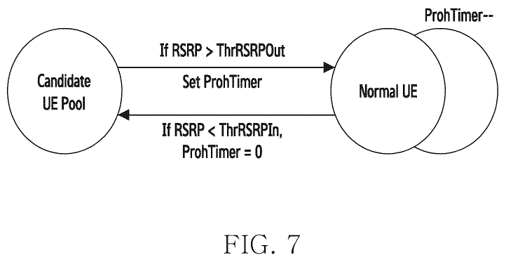

According to various embodiments, the determining of the at least one UE from the candidate UEs according to the measurement information of the serving cell of each of the candidate UEs may include determining, as the at least one UE, UE(s) whose measurement information of the serving cell satisfies a specified condition for a specified number of slots among the candidate UEs. For example, it may be implemented by setting a prohibitive timer that only a candidate UE that satisfies the specified condition for the specified number of slots is determined to be the final candidate UE. FIG. 7 is a schematic diagram illustrating an example determination of a candidate UE. For example, as shown in FIG. 7, a candidate UE may be determined in the following manner.

\textcircled{1} Removing UEs that satisfy the following condition (high SS-RSRP) from a list of candidate UEs (an initial list of candidate UEs may include all UEs), and setting a prohibitive timer ProhTimer=prohTimer (prohTimer is the starting value of the prohibitive timer, e.g., equal to a predetermined number) for these UEs to avoid ping-pong switching, and every slot passed, the value of the prohibitive timer will be reduced by 1, so that it may be realized that the switching is performed only when UE_{RSRP}<ThrRSRPIn is satisfied in a predetermined number of slots.

UE_{RSRP}>ThrRSRPOut

Where, UE_{RSRP} denotes the SS-RSRP value reported by UE.

\textcircled{2} determining a UE that satisfies the following conditions (low SS-RSRP and the timer value is 0) as the final candidate UE.

UE_{RSRP}<ThrRSRPIn

ProhTimer=0

The parameter thresholds involved in the above process, including the values of ThrRSRPOut, ThrRSRPIn, and prohTimer, are dynamically configurable.

After the final candidate UE is determined, the base station may, for example, transmit an EventTriggerConfig message to a newly added candidate UE in the CONNECTED state via the RRCReconfiguration configuration to cause the candidate UE to perform the additional A3 measurement to obtain the measurement information of its interference cell.

Returning to FIG. 6, next, at step S620, a target block error rate (BLER) for a target UE in the at least one UE is adjusted according to the measurement information of the interference cell(s) and/or the traffic information of the interference cell(s).

According to various embodiments, step S620 may include, for example, determining the target UE according to the measurement information of the interference cell(s) and/or the traffic information of the interference cell(s); and adjusting the target BLER for the target UE according to measurement information and/or traffic information of an interference cell of the target UE.

In the following, it is first described how the target UE is determined.

According to various embodiments, a UE with large neighbor cell interference fluctuation may be selected as the target UE based on the measurement information of the interference cell(s) and the traffic information of the interference cell(s). In this disclosure, a neighboring cell may also be referred to as a “neighbor cell”.

For example, the determining of the target UE according to the measurement information of the interference cell(s) and/or the traffic information of the interference cell(s) may include obtaining a first classification result by classifying the interference cell(s) according to the measurement information of the interference cell(s); obtaining a second classification result by classifying slots of the UE based on the traffic information of the interference cell(s) and the first classification result; and determining the target UE based on the second classification result.

In a case in which the interference cell is a neighboring cell, for example, the target UE may be determined by:
(1) performing classification on strong interference neighbor cells based on measurement information reported by the at least one UE

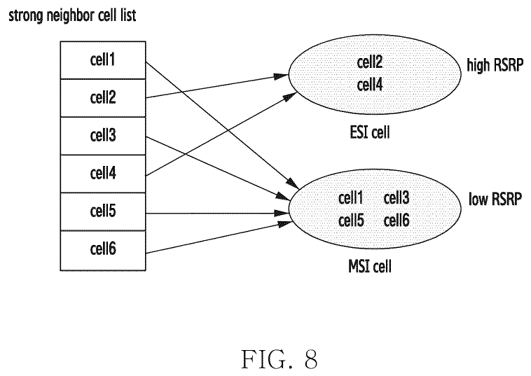

For example, the measurement information of the neighboring cell reported by the at least one UE may be measurement information of the strong interference cell reported by the UE via A3 measurement, e.g., a measured value of the signal strength of the strong interference cell. In this case, the base station may classify the interference cells in the strong interference neighbor cell list into extreme-strong interference cells and medium-strong interference cells based on the measured value of the signal strength, as shown in FIG. 8.

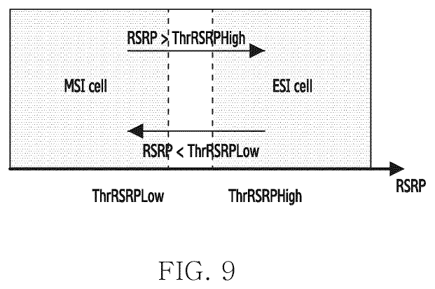

FIG. 9 is a schematic diagram illustrating an example classification process for a strong interference neighbor cell. As shown in FIG. 9, initially, the strong interference neighbor cell of the UE may be classified as a medium-strong interference (MSI) cell. To avoid ping-pong switching, a dual threshold classification mechanism may be set:
\textcircled{1} If the jth neighbor cell of the UE is the medium-strong interference cell and the following condition (high signal strength) is satisfied, this neighbor cell is adjusted to be the extreme-strong interference (ESI) cell.

RSRP(j)>ThrRSRPHigh

Where RSRP (j) denotes the RSRP value of the jth neighbor cell reported by the UE.
\textcircled{2} If the jth neighbor cell of the UE is the extreme-strong interference cell and the following condition (low signal strength) is satisfied, this neighbor cell is adjusted to be a medium-strong interference cell.

RSRP(j)<ThrRSRPLow

The parameter thresholds involved in the above process, including the values of ThrRSRPHigh and ThrRSRPLow, are dynamically configurable.
(2) performing classification on slots of the UE (also referred to as classification on slot indexes of the UE)

For example, the base station may classify all slot indexes of the UE into medium traffic slots and non-medium traffic slots based on the traffic information of the neighbor cell and the result of the strong interference neighbor cell classification.

For example, the traffic information of the neighbor cell may be obtained through the interface interaction between base stations or the interface interaction between the RIC and the base station, and may be the traffic on each slot index obtained by averaging the traffics on the same slot indexes within a period W (e.g., 1 hour). The formula for calculating the slot index is:

$$slot index = slot \% K$$

where slot denotes the number of slots and K may be the slot length (e.g., 10) of the centralized scheduling period for the small packet.

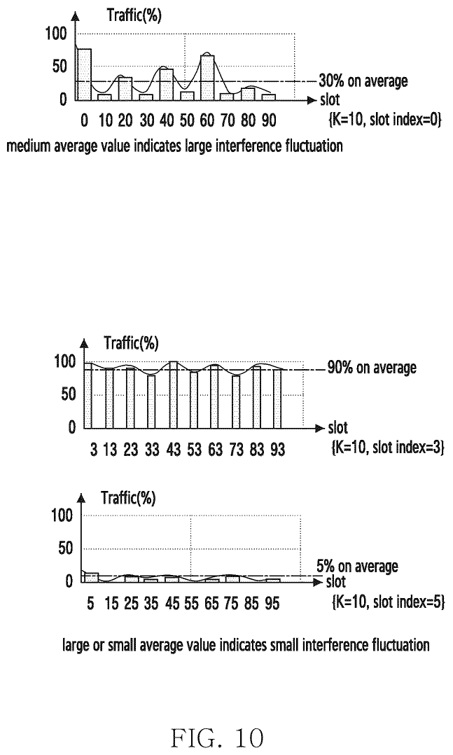

The traffic information of the neighbor cell may indicate a degree of interference fluctuation of the neighbor cell to the user. As shown in FIG. 10, medium traffic indicates large neighbor cell interference fluctuation because the neighbor cell's traffic on the number of slots corresponding to that slot index fluctuates high and low such that the average is in the medium range; high and low traffics indicate small neighbor cell interference fluctuation because when the neighbor cell's traffic on the number of slots corresponding to that slot index is mostly large such that the average is high, and, by the same token, when the neighbor cell's traffic on the number of slots corresponding to that slot index is mostly small such that the average is low.

For example, the classification mechanism for each slot index may be as follows:
\textcircled{1} For a certain index of a certain UE, if the UE has an extreme-strong interference cell, this slot index of the UE is classified as a medium traffic slot if the traffic of at least one extreme-strong interference cell on this slot index satisfies the medium traffic condition.
\textcircled{2} For a certain index of a certain UE, if the UE has no extreme-strong interference cell, this slot index of the UE is classified as the medium traffic slot if the traffics of more than a predetermined percentage (e.g., 50%) of medium-strong interference cells on this slot index satisfy the medium traffic condition.
\textcircled{3} If a certain index of a certain UE does not satisfy the above two conditions, this slot index of the UE is classified as a non-medium traffic slot.

The medium traffic condition is:

ThrLoadHigh>Traffic(j)>ThrLoadLow

Where Traffic (j) denotes the traffic of the jth neighbor cell of the UE on a certain slot index, and ThrLoadHigh and ThrLoadLow are parameter thresholds, which are dynamically configurable.

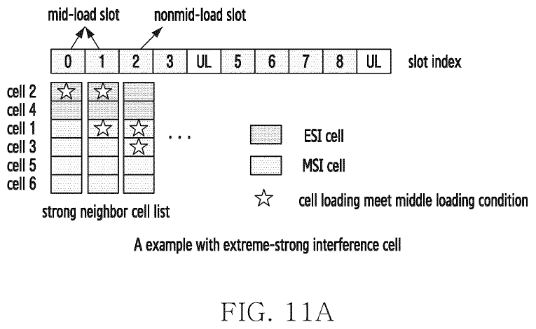

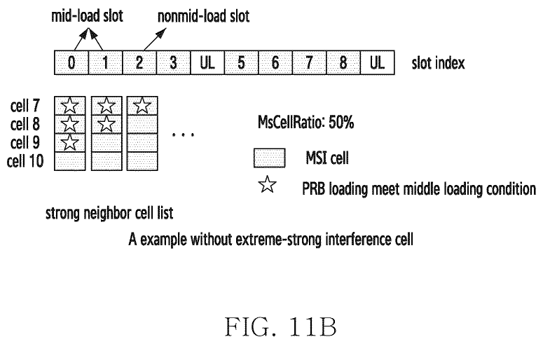

For example, the classification effect may be as shown in FIGS. 11A and 11B, wherein FIG. 11A illustrates a classification effect of slot indexes of a UE with an extreme-strong interference cell, and FIG. 11B illustrates a classification effect of slot indexes of a UE with no extreme-strong interference cell. Furthermore, in FIGS. 11A and 11B, UL is an uplink slot, which is not considered in the downlink algorithm and thus is not classified.
(3) determining the target UE based on the result of the slot classification

If the slot index of the UE satisfies the following condition (there are more medium traffic slots), which indicates that the UE is subjected to large neighbor cell interference fluctuation, the UE may be identified as the target UE, otherwise the UE is an ordinary user.

NumMidSlot>ThrMidRatio*K

Where, NumMidSlot denotes the number of UE neighboring cells with medium traffic slot indexes, and ThrMidRatio is a parameter threshold with dynamically configurable values, which may be determined based on a channel condition, a Quality of Service (QOS) requirement, and a channel load.

Above, the examples of determining the target UE based on both the measurement information of the interference cell(s) and the traffic information of the interference cell(s) are described. However, the manner of determining the target UE is not limited to the above examples. For example, the target UE may also be determined based only on the measurement information of the interference cell(s), such as classifying the interference cell(s) based on the measurement information of the interference cell(s) of the UE and determining whether the UE is the target UE based on the classification result, or, determining the UE to be the target UE if the UE has an extreme-strong interference cell. Alternatively, the target UE may be determined based only on the traffic information of the interference cell(s) of the UE, such as classifying the slots of the UE based on the traffic information of the interference cell(s) of the UE and determining whether the UE is the target UE based on the result of the classifying, or, determining the UE to be the target UE if the number of medium traffic slots of the UE exceeds a threshold value.

After determining the target UE, a target BLER for the target UE may be adjusted according to measurement information and/or traffic information of the interference cell(s) of the target UE.

According to various embodiments, step S620 may include at least one of adjusting a target BLER for all slots of the target UE according to measurement information of the interference cell(s) of the target UE and average traffic information on all slots of the interference cell(s) of the target UE; adjusting a target BLER for a set slot of the target UE according to the measurement information of the interference cell(s) of the target UE and traffic information on the set slot of the interference cell(s) of the target UE; or determining a target BLER adjustment method for the target UE according to the measurement information and/or traffic information of the interference cell(s) of the target UE, and adjusting the target BLER for the target UE based on the determined target BLER adjustment method.

According to various embodiments, a fixed target BLER adjustment method may always be used for different interference scenarios, e.g., a UE-level target BLER adjustment method (which may also be referred to as a user-level target BLER adjustment method) may always be used, i.e., the target BLER is adjusted per UE, wherein, for the user-level target BLER adjustment method, the target BLERs for all slots of the UE are the same. In an embodiment, a slot-level target BLER adjustment method may always be used, i.e., the target BLER is adjusted per slot, e.g., the target BLER of a set slot of the UE may be adjusted, such as the target BLER of each slot of the UE may be adjusted. In the disclosure, the user-level target BLER adjustment method may be to adjust the target BLER of all slots for the target UE, and the slot-level target BLER adjustment method may be to adjust the target BLER for a set slot for the target UE. In an embodiment, the target BLER adjustment method may also be dynamically selected. According to embodiments, different target BLER adjustment methods may be used for different interference scenarios:
If the neighbor cell traffics of all slot indexes corresponding to the target UE are not very different (If the neighbor cell traffics of all slot indexes corresponding to the target UE do not have specified difference), the user-level target BLER adjustment method may be adopted for the target UE. This not only can make the actual BLER converge to the target BLER better, but also can reduce the amount of operation. For example., if the target BLER is determined based on an artificial intelligence model, the user-level target BLER adjustment method can reduce the running time of the artificial intelligence model;
Otherwise, the slot-level target BLER adjustment method is adopted for the target user to obtain the maximum user throughput.

According to various embodiments, the target BLER adjustment method for the target UE may be determined based on the measurement information and/or the traffic information of the interference cell(s) of the target UE, for example, an interference intensity of the interference cell(s) of the target UE may be determined based on the measurement information of the interference cell(s) of the target UE, and a target BLER adjustment method for the target UE may be determined based on the interference intensity and the traffic information of the interference cell(s) of the target UE, such as determining whether the user-level target BLER adjustment method or the slot-level target BLER adjustment method is applicable to the target UE.

According to various embodiments, the determining of the target BLER adjustment method for the target UE based on the interference intensity and the traffic information of the interference cell(s) of the target UE may include determining that the target BLER adjustment method for the target UE is to adjust the target BLER for all slots of the target UE if there exists, for the target UE, an interference cell that satisfies a predefined interference intensity and the traffic of the interference cell that satisfies the predefined interference intensity satisfies a predefined traffic related condition, or, if there exists, for the target UE, no interference cell that satisfies the predefined interference intensity and the traffic for interference cells of the target UE all satisfies the predefined traffic related condition; otherwise, determining that the target BLER adjustment method for the target UE is to adjust the target BLER for the set slot of the target UE.

For example, in a case in which the interference cell is a neighboring cell and the interference cell is a strong interference cell as mentioned above, the target BLER adjustment method for the target UE may be determined based on the traffic and interference intensity of the interference cell as follows:
For a certain neighbor cell of the target UE, if all of its slot indexes are medium traffic slots and the standard deviation of the traffics between all slot indexes is less than a certain threshold, this neighbor cell is considered to satisfy a traffic standard deviation judgment condition;
If the target UE has an extreme-strong interference cell, this target UE is determined to be applicable to the user-level target BLER adjustment method when all extreme-strong interference cells satisfy the traffic standard deviation judgment condition; if the target UE has no extreme-strong interference cell, this target UE is determined to be applicable to the user-level target BLER adjustment method when all strong interference cells satisfy the traffic standard deviation judgment condition. Otherwise, this target UE is determined to apply the slot-level target BLER adjustment method. The traffic standard deviation judgment condition is as follows:

$$LoadingSTD ( j ) = \sqrt{\frac{1}{K} {\sum }_{k = 0}^{K - 1} {( Loading ( k , j ) - MeanLoading ( j ) )}^{2}}$$

LoadingSTD(j)<ThrLoadingSTD
where Loading(k,j) is the statistical traffic of the slot index k in the jth neighbor cell of the target UE, MeanLoading(j) is the average traffic of all slot indexes in the jth neighbor cell, LoadingSTD(j) is the traffic standard deviation of the jth neighbor cell, and ThrLoadingSTD is the threshold value of the traffic standard deviation.

After determining the target BLER adjustment method for the target UE, the target BLER for the target UE may be adjusted based on the determined target BLER adjustment method.

According to various embodiments, if the target BLER adjustment method is the user-level target BLER adjustment method, the target BLER for all slots of the target UE is adjusted based on the measurement information of the interference cell(s) of the target UE and the average traffic information on all slots of the interference cell(s) of the target UE; and, if the target BLER adjustment method is the slot-level target BLER adjustment method, the target BLER for the set slot of the target UE is adjusted based on the measurement information of the interference cell(s) of the target UE and the traffic information on the set slot of the interference cell(s) of the target UE.

In an embodiment, as described above, instead of dynamically selecting a target BLER adjustment method for the target UE, the user-level target BLER adjustment method may also be fixedly adopted, i.e., always adjusting the target BLER for all slots of the target UE based on the measurement information of the interference cell(s) of the target UE and the average traffic information on all slots of the interference cell(s) of the target UE. In an embodiment, the slot-level target BLER adjustment method may also be fixedly adopted, i.e., always adjusting the target BLER for the set slot of the target UE based on the measurement information of the interference cell(s) of the target UE and the traffic information on the set slot of the interference cell(s) of the target UE.

According to various embodiments, the larger the interference fluctuation of the interference cell is, the higher the target BLER for the target UE preferably is. When the traffic of the interference cell is too low or too high, the interference fluctuation of the interference cell is relatively small, and, at this time, a smaller target BLER is applicable for the target UE; on the contrary, when the traffic of the interference cell is at a medium level, the interference fluctuation of the interference cell is relatively large, and at this time, a larger target BLER is applicable for the target UE to obtain a higher performance gain.

According to various embodiments, both the user-level target BLER adjustment method and the slot-level target BLER adjustment method may be used to determine the target BLER by either an Artificial Intelligence (AI) method or a non-AI method.

For example, in a case in which the target BLER adjustment method used for the target UE is the user-level target BLER adjustment method, the adjusting of the target BLER for all slots of the target UE according to the measurement information of the interference cell(s) of the target UE and the average traffic information on all slots of the interference cell(s) of the target UE may include predicting a target BLER for all slots of the target UE using a pre-trained artificial intelligence model according to the measurement information of the interference cell(s) of the target UE and the average traffic information on all slots of the interference cell(s) of the target UE, and adjusting the target BLER for all slots of the target UE based on the predicted target BLER (i.e., the AI method); or determining a target BLER for all slots of the target UE using a pre-established mapping relationship between an interference fluctuation level and the target BLER according to the measurement information of the interference cell(s) of the target UE and the average traffic information on all slots of the interference cell(s) of the target UE, and adjusting the target BLER for all slots for the target UE based on the determined target BLER (i.e., a non-AI method), wherein the interference fluctuation level is determined based on the average traffic information.

For example, in a case in which the target BLER adjustment method used for the target UE is the slot-level target BLER adjustment method, the adjusting of the target BLER for the set slot of the target UE according to the measurement information of the interference cell(s) of the target UE and the traffic information on the set slot of the interference cell(s) of the target UE may include predicting a target BLER for the set slot of the target UE using a pre-trained artificial intelligence model according to the measurement information of the interference cell(s) of the target UE and the traffic information on the set slot of the interference cell(s) of the target UE, and adjusting the target BLER for the set slot of the target UE based on the predicted target BLER (i.e., a AI method); or determining a target BLER for the set slot of the target UE using a pre-established mapping relationship between an interference fluctuation level and the target BLER according to the measurement information of the interference cell(s) of the target UE and the traffic information on the set slot of the interference cell(s) of the target UE, and adjusting the target BLER for the set slot of the target UE based on the determined target BLER (i.e., a non-AI method), wherein the interference fluctuation level is determined based on the traffic information on the set slot.

In the present disclosure, “slot” may be used interchangeably with “slot index”.

In the following, examples of determining the target BLER based on the AI method and determining the target BLER based on the non-AI method are described, respectively. In the following examples, the interference cell is a neighboring cell as an example.

### (i) An Example of a Target BLER Determination Scheme Based on the AI Method

Since the interference intensity and the magnitude of interference fluctuation are different in different neighboring cells, the combined impact on the UE when the interference from all neighboring cells is superimposed together may be evaluated by the AI method to obtain the optimal target BLER for that UE.

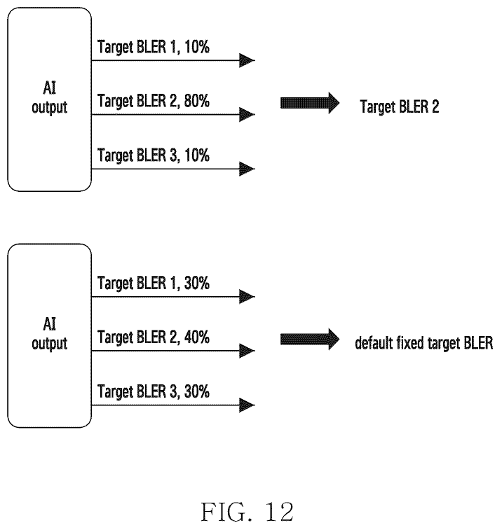

The training data for the AI model may be generated by simulating a wide variety of interference scenarios through a system-level simulation platform. As an example, considering the requirements of the 5G system and the complexity of the AI implementation, a predetermined number (e.g., three, but not limited to this) of interference fluctuation levels and their corresponding target BLERs may be pre-designed. Then, as shown in FIG. 12, the probability of each of the three target BLERs may be predicted by the AI model, and, if the largest one of the three probabilities exceeds a certain threshold (e.g., 70%), the target BLER corresponding to the largest probability is selected as the predicted target BLER, otherwise, a default fixed target BLER is used.

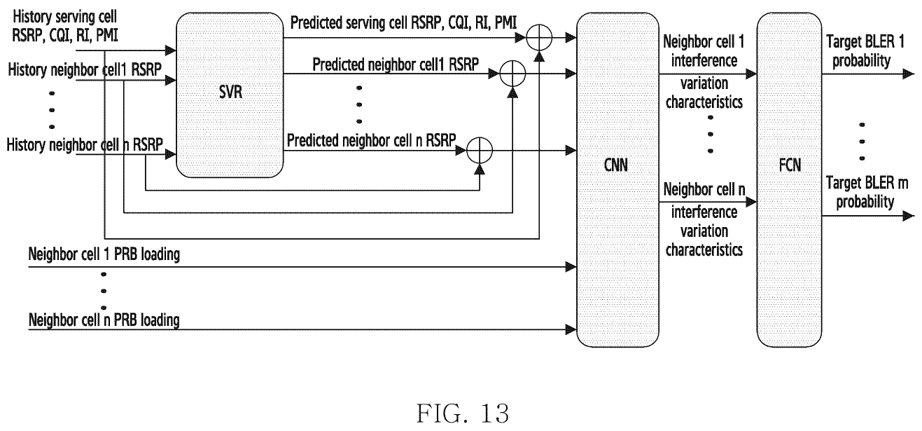

FIG. 13 is a schematic diagram illustrating an example of an AI model according to various embodiments of the present disclosure.

As shown in FIG. 13, the AI model may include three network models including a Support Vector Regression (SVR), a Convolutional Neural Network (CNN), and a Fully Convolutional Network (FCN). The inputs to the AI model may include measurement information of a service cell (e.g., RSRP, CQI, RI, PMI), as well as measurement information (e.g., RSRP) and traffic of a neighboring cell. It is noted that although the inputs to the AI model in the example of FIG. 13 include the measurement information of the serving cell, it is also possible to use the AI model to predict the target BLER without the measurement information of the serving cell.

As shown in FIG. 13, the SVR network model may be used to predict the RSRP, CQI, RI, PMI of the service cell and the RSRP of the neighbor cell for the next time by using the historical data of the RSRP, CQI, RI, PMI of the service cell and the RSRP of the neighbor cell as inputs.

The CNN network model may be used to extract interference variation features of the neighbor cell, the interference variation features including, for example, mean, variance, extreme value, gradient, and fluctuation coefficients of the interference, etc. The inputs of the CNN network model may include the RSRP, CQI, RI, PMI of the service cell and the RSRP of the neighbor cell output by the SVR model through predicting and the traffic of the neighbor cell. The RSRP of the neighbor cell may be used to reflect the intensity of the neighbor cell interference, the neighbor cell traffic may be used to reflect the magnitude of the neighbor cell interference fluctuation, and the RSRP, CQI, RI, and PMI of the service cell may be used to help extract the interference fluctuation features, e.g., if the RSRP, CQI, RI, and PMI of the service cell change faster, this may indicate that the target user is moving and that the neighbor cell interference thereof is changing faster as well.

The FCN network model may use the interference variation features of the neighbor cell output from the CNN network as inputs for determining the final target BLER probability. According to the simulation results of the system-level simulation platform for a wide variety of interference scenarios, and taking into account the requirements of the 5G system and the complexity of the AI implementation, for example, three values of 10%, 20%, and 30% may be selected as the typical values of the target BLER, but if the AI network may support a higher complexity of computation in the future, it may also be considered to support more typical values of the target BLER.

Although for both the user-level target BLER adjustment method and the slot-level target BLER adjustment method, the target BLER may be determined by the AI method, but the specific determination methods may be different.

For example, if the user-level target BLER adjustment method is applied to the target UE, the average traffic on all slots may first be calculated separately for each neighbor cell, and then the average traffic of each neighbor cell may be used as an input to the AI model to predict a user-level target BLER by the AI model, which is the same for all slots of the target UE. For example, as shown in FIG. 13, in a case of the user-level target BLER adjustment method, the traffic of neighbor cell n may be the average traffic on all slots of the neighboring cell of the target UE, and the predicted target BLER may be a target BLER for all slots of the target UE.

For example, if the slot-level target BLER adjustment method is applied to the target UE, the traffic of the set slot of each neighbor cell may be used as an input to the AI model, and the slot-level target BLER may be predicted for the set slot by the AI model. Here, the set slot may be each of all the slots, or a certain slot of all the slots. For example, as shown in FIG. 13, in a case of the slot-level target BLER adjustment method, the traffic of neighbor cell n may be the average traffic on each slot of the neighboring cell of the target UE, and the predicted target BLER may be the target BLER for each slot of the target UE.

### (ii) An Example of a Target BLER Determination Scheme Based on the Non-AI Method

According to the embodiment, the target BLER for the target user may be adjusted according to the fluctuation magnitude of the neighbor cell interference and the interference intensity, based on the degree of interference impact of the extreme-strong interference cell, or the probability of interference impact of the medium-strong interference cell.

In order to obtain the mapping relationship between the neighbor cell traffic and the target BLER, a mapping relationship table of the neighbor cell traffic, an interference fluctuation level, and the target BLER may be predefined by simulating a wide variety of interference scenarios by the system-level simulation platform for simulation.

Considering the requirements of the 5G system, for example, three interference fluctuation levels and their corresponding target BLERs may be designed, but the disclosure is not limited in this respect, and more interference fluctuation levels may also be designed.

For example, a specific scheme for determining the target BLER based on a non-AI method may include:

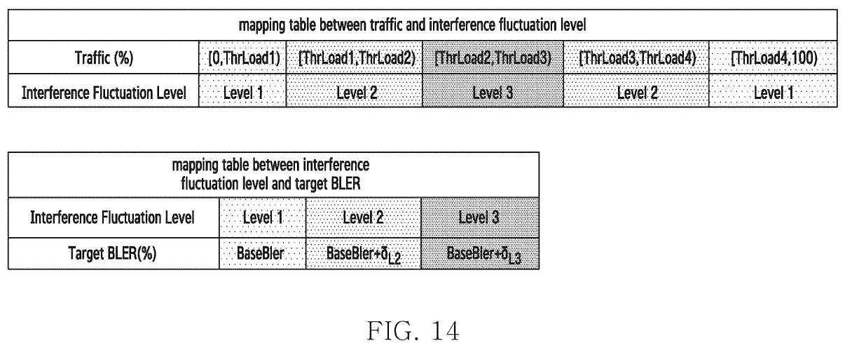

First, a mapping relationship table of neighbor celling traffics, interference fluctuation levels, and target BLERs may be predefined. As an example, the mapping relationship table may be shown in FIG. 14, wherein, in the mapping relationship table of FIG. 14, the traffic threshold 1 to the traffic threshold 4, denote the neighbor cell traffic threshold value, the base BLER is the adaptive base target BLER, 812 is the BLER offset of the level 2 with respect to the level 1, and 813 is the BLER offset of the level 3 with respect to the rank level 1.

Then, the neighbor cell interference fluctuation level and the target BLER for the target user may be determined.

Although for both the user-level target BLER adjustment method and the slot-level target BLER adjustment method, the target BLER may be determined by the non-AI method, the specific determination methods may be different.

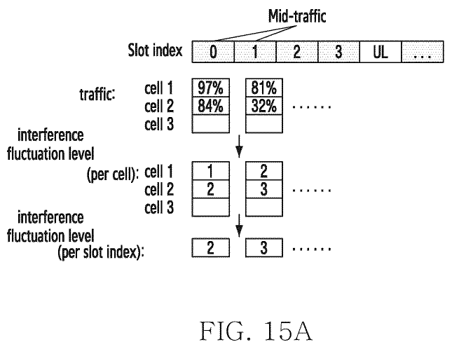

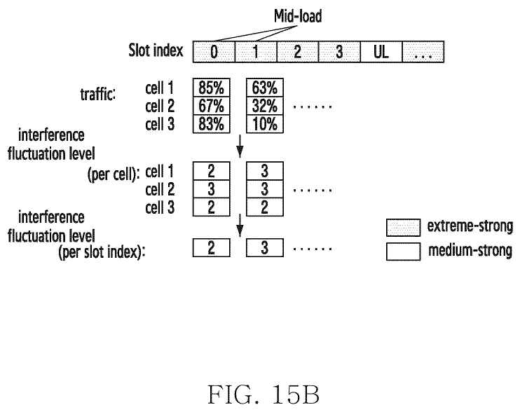

For example, for a target UE to which the slot-level target BLER adjustment method applies, whether the target UE has an extreme-strong interference cell may first be determined based on the measurement information of the neighboring cell reported by the target UE. If it is determined that the target UE has an extreme-strong interference cell based on the measurement information of the neighboring cell reported by the target UE, the following procedure is performed for each slot index, as shown in FIG. 15A:
\textcircled{1} For each extreme-strong interference cell, determining each interference fluctuation level for each extreme-strong interference cell individually according to its traffic using the mapping table of the traffic and the interference fluctuation level;
\textcircled{2} Selecting the largest interference fluctuation level among all extreme-strong interference cells as the interference fluctuation level of the slot index; and
\textcircled{3} Determining the target BLER of the slot index using the mapping table of the interference fluctuation level and the target BLER based on the interference fluctuation level of the slot index;

For the target UE to which the slot-level target BLER adjustment method applies, if it is determined that the target UE has no extreme-strong interference cell based on the measurement information of the neighboring cell reported by the target UE, the following procedure is performed for each slot index, as shown in FIG. 15B:
\textcircled{1} For each medium-strong interference cell, determining the interference fluctuation level of each medium-strong interference cell individually according to its traffic using the mapping table of the traffic and the interference fluctuation level;
\textcircled{2} Selecting the interference fluctuation level with the largest number of medium-strong interference cells as the interference fluctuation level for this slot index. If the numbers of medium-strong interference cells of two interference fluctuation levels are same, the one with the larger interference fluctuation level is selected as the interference fluctuation level of this slot index.
\textcircled{3} According to the interference fluctuation level of this slot index, determining the target BLER of this slot index using the mapping table of the interference fluctuation level and the target BLER.

For a target UE to which the user-level target BLER adjustment method applies, the average traffic may be obtained by first averaging the traffics on all slot indexes of each neighbor cell, and then the above procedure may be performed. The same target BLER will be used for all slot indexes of the target UE to which the user-level target BLER adjustment method applies.

When the actual traffic of the interference cell does not match the obtained traffic information of the interference cell, the target BLER determined based on the traffic information of the interference cell and the actual situation may be mismatched, which may lead to transmission performance loss. For example, when the actual neighbor cell traffic does not match the obtained neighbor cell statistics traffic, the target BLER determined based on the neighbor cell statistics traffic and the actual situation will be mismatched, which may lead to performance loss. To cope with such a situation, the present disclosure further proposes that channel state self-checking is performed by the network node to check the channel fluctuation state, and thus determine whether to apply the above determined target BLER for the target UE.

Optionally, according to various embodiments, the method shown in FIG. 6 may further include obtaining a channel fluctuation state for the target UE; and determining whether to continue using a current target BLER according to the channel fluctuation state.

According to various embodiments, the obtaining of the channel fluctuation state for the target UE may include obtaining the channel fluctuation state according to a channel difference between different slots of the target UE, wherein the channel difference between different slots of the target UE includes a difference in actual BLERs between different slots of the target UE, or a difference in signal-to-interference noise ratios (SINRs) between different slots of the target UE. For example, the channel fluctuation state may be periodically obtained based on the channel difference between different slots of the target UE.

For example, if the target BLER adjustment method for the target UE is the user-level target BLER adjustment method, the channel fluctuation state may be periodically obtained based on the actual BLER difference between different slots of the target UE; if the target BLER adjustment method for the target UE is the slot-level target BLER adjustment method, the channel fluctuation state may be periodically obtained based on the signal-to-interference noise ratio (SINR) difference between different slots of the target UE.

According to various embodiments, the determining of whether to continue using the current target BLER according to the channel fluctuation state may include: marking a channel fluctuation state acquisition period as an activate state or a deactivate state according to the channel fluctuation state; if the channel fluctuation state acquisition period is marked as the activate state, continuing using the current target BLER during the channel fluctuation state acquisition period; and if the channel fluctuation state acquisition period is marked as the deactivate state, using a default fixed target BLER during the channel fluctuation state acquisition period.

For example, the channel fluctuation state self-checking may be performed in the following sample ways:
(1) Regularly checking the channel fluctuation state based on the channel differences between all slot indexes, to reflect the interference fluctuation in time:
\textcircled{1} For the slot-level target BLER adjustment method, if the signal-to-interference noise ratio (SINR) difference is detected to be less than a threshold value, a period N is marked as the deactivate state, otherwise, it is marked as the activate state;
\textcircled{2} For the user-level target BLER adjustment method, if the actual BLER difference is detected to be greater than a threshold value, the period N is marked as the deactivate state, otherwise, it is marked as the activate state;
(2) For the activate state, this period continues to use the current target BLER, e.g., the target BLER determined above; for the deactivate state, this period uses a default fixed target BLER.

Where the period N is a period of the channel self-checking, which is smaller than a period W.

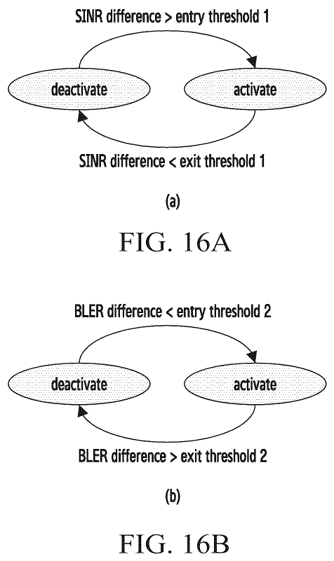

Specifically, for the slot-level target BLER adjustment method, the neighbor cell traffics on different slot indexes should be different, so the SINRs on different slot indexes should also be different. Therefore, the SINR difference between slot indexes may be used as a basis for channel state self-checking. For example, the self-checking may be performed in the following way:
1) Since the larger the target BLER is, the higher the corresponding SINR is, the SINRs on the slot indexes at different target BLERs cannot be directly compared, the SINR on each slot index is aligned using a SINR compensation factor ε(k).

$$SINR = actual SINR - ε ( k ) .$$

$$ε ( k ) = ( ( TargetBLER ( k ) - TargetBLER ( kmin ) ) * BaseCompFactor$$

where TargetBLER(k) is the target BLER determined for slot index k, TargetBLER(kmin) is the smallest target BLER among all slot indexes, and BaseCompFactor is the basic compensation factor.
2) The SINR difference between the largest SINR and the smallest SINR in all slot indexes is calculated;
3) If the SINR difference is greater than a threshold, the period N is marked as the “activate” state. If not, it is marked as the “deactivate” state. To prevent ping-pong switching of states, as shown in FIG. 16A, for example, a double threshold may be set, where an entry threshold 1 is greater than an exit threshold 1. If the SINR difference is greater than the entry threshold 1, the period N is marked as the “activate” state, if the SINR difference is less than the exit threshold 1, the period N is marked as the “deactivate” state.

For the user-level target BLER adjustment method, there may not be a great difference in the neighbor cell traffics in all slot indexes, so the actual BLERs of different slot indexes may be similar. Therefore, the actual BLER difference between slot indexes may be used as a basis for self-checking. For example, the self-checking may be performed in the following way:
\textcircled{1} Calculating the difference between the largest BLER and the smallest BLER among all slot indexes
\textcircled{2} Marking the period N as the “activate” state if the BLER difference is less than a threshold value, otherwise marking it as the “deactivate” state. To prevent ping-pong switching of states, as shown in FIG. 16B, a double threshold may be set, where an entry threshold 2 is smaller than an exit threshold 2. If the actual BLER difference is smaller than the entry threshold 2, the period N is marked as the “activate” state. If the actual BLER difference is greater than the exit threshold 2, the period N is marked as the “deactivate” state.

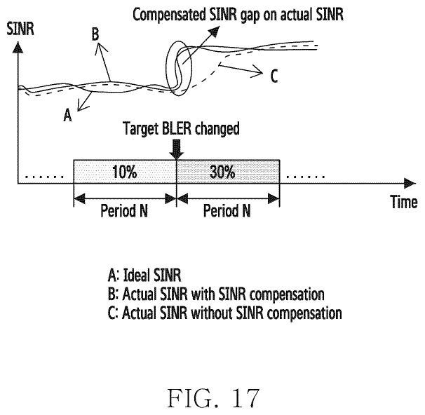

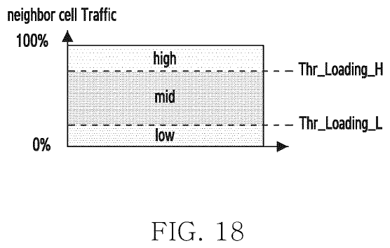

According to embodiments, optionally, the method shown in FIG. 6 may further include: performing a signal-to-interference noise ratio (SINR) compensation based on the target BLER after adjusting and the target BLER before adjusting. By performing the SINR compensation, the actual BLER may be caused to quickly converge to the adjusted target BLER. For example, as shown in FIG. 17, when the target BLER is adjusted, such as from 10% to 30%, if the SINR is compensated, the actual BLER may be caused to quickly converge to the adjusted target BLER.

Different target BLERs correspond to different ideal SINRs, and the higher the target BLER is, the larger the ideal SINR is. When the target BLER changes, the base station may perform the SINR compensation based on a difference between the target BLER after adjusting and the target BLER before adjusting. According to various embodiments, the SINR difference between the target BLER after adjusting and the target BLER before adjusting may be determined based on a compensation factor, and the SINR may be compensated based on the determined SINR difference. For example, the base station may calculate a SINR difference between a new target BLER and the current target BLER based on a basic compensation factor (BaseCompFactor), and compensate the actual SINR based on the calculated SINR difference.

According to embodiments, the SINR compensation is performed when the target BLER of the UE is adjusted. For example, when the state of the target UE/normal UE is changed, when the target BLER adjustment method of the target UE is changed, when the “activate”/“deactivate” state of the channel fluctuation state checking period of the target UE is changed, all of those cases may cause the target BLER of the UE to be adjusted, and the SINR compensation is performed when the target BLER is adjusted. Depending on different target BLER adjustment methods to which the target UE applies, performing the SINR compensation may be performed either by performing an user-level SINR compensation or a slot-level SINR compensation.

For example, if the slot-level SINR compensation is performed, the SINR may be calculated by the following equation for a set slot index k:

$$SINR ( k ) = SINR ( k ) + ( ( CurrentTargetBLER ( k ) - PreviousTargetBLER ( k ) ) * BaseCompFactor$$

Where CurrentTargetBLER(k) is the newly adjusted target BLER for the slot index k of the current period and PreviousTargetBLER(k) is the target BLER for the slot index k of the previous period.

For example, if the user-level SINR compensation is performed, the SINR for the target UE may be calculated by the following equation:

$$SINR = SINR + ( ( CurrentTargetBLER - PreviousTargetBLER ) ) * BaseCompFactor$$

Where CurrentTargetBLER is the newly adjusted target BLER of the current period and PreviousTargetBLER is the target BLER of the previous period.

According to various embodiments, the network node may be a base station, in which case, optionally, in order to further improve the performance of the algorithm and reduce the computational complexity of the base station, it may be possible for the RIC to control whether or not the base station is allowed to perform the target BLER adjustment and it may also be possible for the RIC to perform the determination of the target BLER, and then transmit the determination result to the base station. In this case, optionally, although not shown, the method shown in FIG. 6 may further include receiving, from a radio access network intelligent controller (RIC), indication information indicating whether the base station is allowed to perform a target BLER adjustment. Accordingly, step S620 may include, if the indication information indicates that the base station is allowed to perform the target BLER adjustment, adjusting the target BLER for the target UE based on the measurement information of the interference cell(s) and/or the traffic information of the interference cell(s).

For example, the indication information may be transmitted by the RIC based on the traffic information of the interference cell(s). For example, each cell may separately report its traffic to the RIC, the RIC knows the neighboring cell of the serving cell of the UE, and thus may obtain the traffic information of the neighboring cell of the UE, and may determine whether the base station is allowed to perform the target BLER adjustment based on the traffic information of the neighboring cell, and thus transmit the corresponding indication information. In a case in which the network node is a base station, optionally, the method shown in FIG. 6 may further include transmitting the traffic information of the base station to the RIC. For example, the RIC may, based on the traffic information reported by each of the base station and the neighboring cell, determine whether the base station is allowed to perform the target BLER adjustment, and thus transmit the corresponding indication information. However, the manner of determining whether the base station is allowed to perform the target BLER adjustment is not limited to this, e.g., the RIC may also consider other factors to determine whether the base station is allowed to perform the target BLER adjustment. The manner in which the RIC controls whether the base station is allowed to perform the target BLER adjustment will be described below when describing the method performed by the RIC, and will not be described herein.

Optionally, the determination of the target BLER may be performed by the RIC, and then the result of the determination is transmitted to the base station. Thus, optionally, step S620 shown in FIG. 6 may include transmitting, to the RIC, the measurement information of the interference cell(s) of the target UE; receiving, from the RIC, a target BLER for the target UE determined by the RIC according to the measurement information and traffic information of the interference cell(s) of the target UE; and adjusting the target BLER for the target UE based on the received target BLER. Optionally, the channel fluctuation state for the UE may be further obtained and whether to continue using the new target BLER may be determined based on the channel fluctuation state. In addition, the way in which the RIC determines the target BLER for the target UE based on the measurement information and the traffic information of the interference cell(s) of the target UE may be the same as that the base station determines the new target BLER for the target UE based on the measurement information and the traffic information of the interference cell(s) of the target UE as described above, and therefore will not be repeated.

Referring back to FIG. 6, after adjusting the target BLER for the target UE based on the measurement information of the interference cell(s) and/or the traffic information of the interference cell(s), at step S630, data may be transmitted to the target UE based on the adjusted target BLER. For example, the data may be transmitted to the target UE based on the channel state information reported by the target UE and the adjusted target BLER. According to the method described in FIG. 6, since the network node may obtain measurement information of interference cell(s) of at least one UE, adjust a target BLER for a target UE in the at least one UE based on the measurement information of the interference cell(s) and/or traffic information of the interference cell(s), and transmit data to the target UE based on the adjusted target BLER, the target BLER of the target UE may be adjusted adaptively, which can improve data transmission performance and user communication experience.

As described above, according to various embodiments of the present disclosure, in order to reduce the burden of the base station, the determination of the target BLER may be performed by the RIC, and then the determination result may be transmitted to the base station. Thus, in the method described with reference to FIG. 6, if the network node is a RIC, the obtaining of the measurement information of the interference cell(s) of the at least one UE in step S610 may include receiving measurement information of the interference cell(s) of the at least one UE reported by the base station, and the obtaining the traffic information of the interference cell(s) may include the RIC receiving traffic information of the interference cell(s) reported by the interference cell(s). For example, the RIC may receive measurement information for the neighboring cell of the target UE determined above reported by the base station.

Furthermore, if the network node is a RIC, step S620 may include determining the target BLER for the UE based on the measurement information of the interference cell(s) and/or the traffic information of the interference cell(s), and transmitting the determined target BLER to the base station. The manner in which the RIC determines the target BLER for the UE based on the measurement information of the interference cell(s) and/or the traffic information of the interference cell(s) may be the same as that the base station determines the target BLER for the target UE based on the measurement information of the interference cell(s) and the traffic information of the interference cell(s) as described above. For example, the target BLER for the target UE may also be determined based on an AI method, or the target BLER for the target UE may also be determined based on a non-AI method, which will not be repeated here.

If the network node is a RIC, step S630 may include controlling the base station to transmit data to the target UE based on the determined target BLER. In an embodiment, as mentioned above, it may be controlled by the RIC whether or not the base station performs the target BLER adjustment. Accordingly, the controlling of the base station to transmit the data to the target UE based on the determined target BLER may include transmitting indication information to the base station based on the traffic information, wherein the indication information indicates whether or not the base station is allowed to perform the target BLER adjustment, i.e., indicates whether or not it is allowed to perform the target BLER adaptive function. That is, the indication information indicates whether the cell-level target BLER adaptation is ON or OFF. For example, the RIC may predict traffic at a future moment based on the traffic information reported by each cell, e.g., predict the traffic at the next moment using an AI module (e.g., SVR), and perform the cell-level target BLER adaptive switch judgment based on the predicted traffic.

According to various embodiments, the transmitting of the indication information to the base station based on the traffic information may include determining a strong interference cell among the interference cell(s), wherein the strong interference cell is a cell among the interference cell(s) that satisfies a predefined condition; determining, based on traffic information of the strong interference cell, a loading type of each slot of the strong interference cell; determining, according to the loading type of each slot of the strong interference cell, an interference type of each slot of a serving cell of the UE; and/or determining whether the base station is allowed to perform the target BLER adjustment based on the interference type of each slot of the serving cell, and transmitting the indication information to the base station according to a result of the determination.

For example, in a case in which the interference cell is a neighboring cell, the cell-level target BLER adaptive switch judgment may be performed based on the following process, and then corresponding indication information may be transmitted based on the judgment result:
(1) Selecting a strong interference neighboring cell

For example, the RIC may select a strong interference neighbor cell based on switch information of the serving cell. Here, the switch information may be the cumulative number of times a UE has switched from the neighbor cell to the serving cell, and if a cell A is a strong interference cell for a cell B, then the cell B is also a strong interference cell for the cell A.
(2) Determining a loading type for each slot index for each strong interference cell

For example, the RIC classifies each slot index into one of the following three loading types based on the predicted traffic of each strong interference cell, as shown in FIG. 18:
If the traffic corresponding to a slot index k of a strong interference cell>Thr_Loading_H, the loading type of the slot index k of the strong interference cell is a high traffic type
If the traffic corresponding to the slot index k of the strong interference cell<Thr_Loading_L, the loading type of the slot index k of the strong interference cell is a low traffic type
Otherwise, the loading type of the slot index k of the strong interference cell is a medium traffic type, which indicates that the interference fluctuation of the strong interference cell is apparent.

where Thr_Loading_H and Thr_Loading_L are the high threshold value and low threshold value of the neighbor cell traffic, respectively, and Thr_Loading_H is greater than Thr_Loading_L.
(3) Judging the cell-level target BLER adaptive switch

For example, the interference type of the slot index of the serving cell may be determined first based on the loading type of each strong interference cell. For a slot index, if one of the strong interference neighbor cells is the medium traffic type, the slot index is marked as “medium”, otherwise it is marked as “non-medium”.

Second, the RIC may determine the target BLER adaptive switch based on the determined interference type of each slot index of the service cell. For example, if NumMidLoadingType>ThrTypeNum, the cell-level BLER adaptive switch is set to “ON”, otherwise it is set to “OFF”.

where NumMidLoading Type is the number of slot indexes marked as “medium” for the serving cell, and ThrTypeNum is a threshold value.

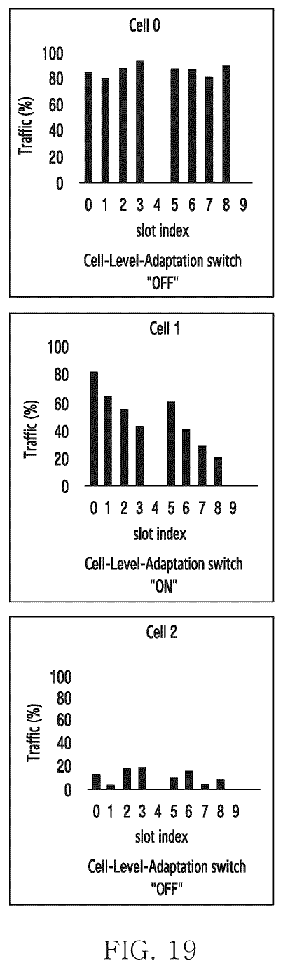

For example, as shown in FIG. 19, the number of slot indexes of the medium traffic type of a cell 1 exceeds the threshold value and, the cell-level BLER adaptive switch of the cell 1 may be set to “ON”. The numbers of slot indexes of the medium traffic type of a cell 0 and a cell 2 do not exceed the threshold value, and the cell-level BLER adaptive switches of the cell 0 and the cell 2 may be set to “OFF”.

According to various embodiments, the base station performs the target BLER adjustment only when the cell-level target BLER adaptive switch is “ON”.

Since the RIC determines the target BLER for the UE based on the measurement information of the interference cell of the UE and/or the traffic information of the interference cell reported by the base station, and transmits the determined target BLER to the base station, the burden and complexity of the base station may be reduced, and the efficiency of the target BLER adjustment may be improved, thereby further improving the data transmission performance and the communication experience of the user. Furthermore, according to various embodiments of the present disclosure, it involves communication with the UE when the base station performs the target BLER adjustment. Therefore, the present disclosure also provides a method performed by the UE.

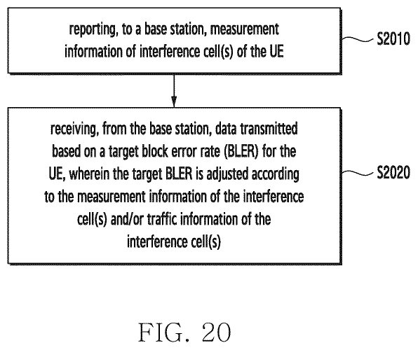

FIG. 20 is a flowchart illustrating a method performed by an example UE according to various embodiments of the present disclosure.

Referring to FIG. 20, at step S2010, measurement information of an interference cell(s) of the UE is reported to a base station. At step S2020, data transmitted based on a target block error rate (BLER) for the UE is received from the base station, wherein the target BLER is adjusted according to the measurement information of the interference cell(s) and/or traffic information of the interference cell(s). The adjustment of the target BLER based on the measurement information of the interference cell(s) and/or the traffic information of the interference cell(s) has been described above in the description of FIG. 6 and will not be repeated here.

As mentioned above, if the UE is determined to be a candidate UE, the base station may transmit to the UE a signaling for configuring the UE to perform the interference cell measurement, to thereby configure it to perform the interference cell measurement. Thus, optionally, the method shown in FIG. 20 may further include receiving, from the base station, a signaling for configuring the UE to perform an interference cell measurement, wherein the measurement information of the interference cell(s) is obtained by the UE through performing the interference cell measurement based on the signaling.

In an embodiment, as mentioned above, the base station may determine the candidate UE based on the measurement information of the service cell reported by the UE, and then transmit to the candidate UE a signaling for configuring it to perform the interference cell measurement. Thus, in an embodiment, the method shown in FIG. 20 may further include transmitting, to the base station, measurement information of a serving cell of the UE, wherein the measurement information of the serving cell is used by the base station to determine whether to transmit the signaling to the UE.

According to the method shown in FIG. 20, since the UE reports the measurement information of the interference cell(s) of the UE to the base station and receives data transmitted based on the target BLER for the UE from the base station, and the target BLER is adapted based on the measurement information of the interference cell(s) and/or the traffic information of the interference cell(s), the data transmission performance and a user's communication experience can be improved.

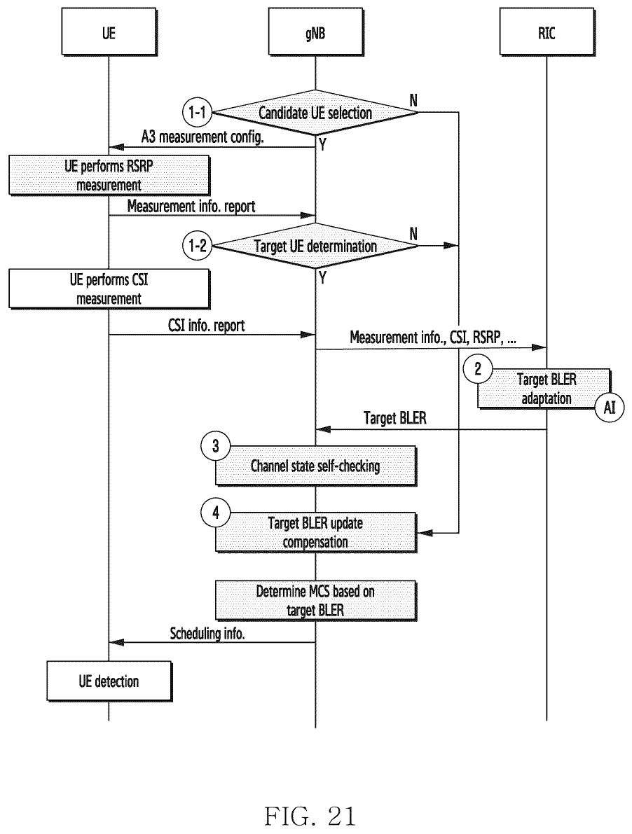

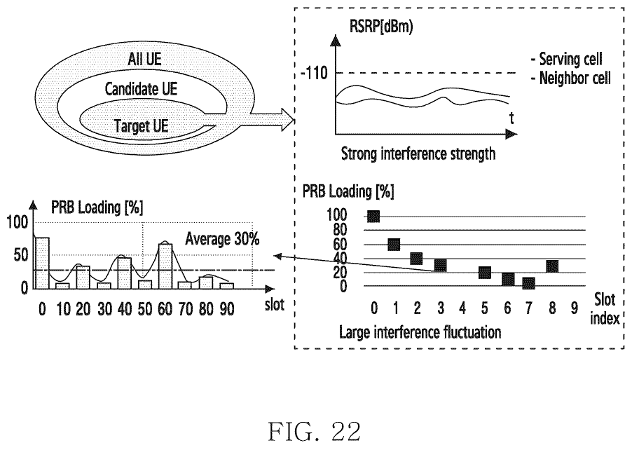

FIG. 21 is a schematic diagram illustrating an example scheme for realizing a target BLER adjustment according to various embodiments of the present disclosure.

As shown in FIG. 21, selection of a candidate UE may first be performed by the base station at step 1-1, e.g., a UE that is not in the center of the cell may be selected as the candidate UE. The manner of selecting the candidate UE has been described above and will not be repeated herein. If the candidate UE is selected at step 1-1, the base station may transmit a signaling to the candidate UE for configuring the candidate UE to perform an interference cell measurement, e.g., transmitting A3 measurement configuration information. The UE performs the interference cell measurement based on the received signaling, e.g., the UE performs an RSRP measurement of the interference cell, and reports the measurement information. In addition, the UE may perform a channel state information (CSI) measurement and report the CSI information.

At step 1-2, the base station performs determination of a target UE. As shown in FIG. 22, a candidate UE with strong interference intensity, large interference fluctuation, and the need to adopt an adaptive target BLER may be selected as the target UE. For example, a non-central UE is selected as the candidate UE based on the desired signal strength and the prohibitive timer, the candidate UE measures the interference intensity of the neighbor cell, reports the measurement result to the base station, and the base station selects the UE with strong interference intensity and large interference fluctuation as the target UE from the candidate UEs based on the neighbor cell interference intensity and the neighbor cell traffic information (e.g., PRB loading information).

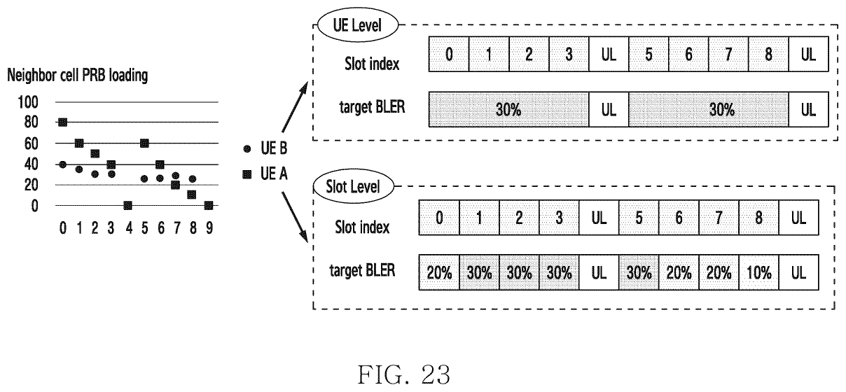

If the target UE is determined, the base station may report the received measurement information (e.g., CSI, RSRP) of the interference cell to the RIC, and the RIC performs the target BLER adaptation at step 2, i.e., determines the target BLER for the target UE, e.g., determines the target BLER for the target UE based on the AI method. The specific determination method has already been described above and will not be repeated here. Furthermore, as described above, an interference intensity of the interference cell of the target UE may be determined based on the measurement information of the interference cell of the target UE, and a target BLER adjustment method for the target UE may be determined based on the interference intensity and the traffic information (e.g., PRB loading information) of the interference cell of the target UE, e.g., whether to perform the UE-level target BLER adjustment or to perform the slot-level target BLER adjustment. As already mentioned above, the determination of whether to perform the UE-level target BLER adjustment or to perform the slot-level target BLER adjustment may be based on the standard deviation (STD) judgment condition of the neighbor cell traffics on all slot indexes. As shown in FIG. 23, the neighbor cell traffics of all slot indexes of a UE B do not differ significantly, and then the UE-level target BLER adjustment method may be used for the UE B; whereas the neighbor cell traffics of all slot indexes of a UE A differ significantly, and then the slot-level target BLER adjustment method may be used for the UE A. As shown in FIG. 23, since the UE-level target BLER adjustment is used for the UE B, the target BLERs of all slots of the UE B are the same, e.g., all are 30%. Since the slot-level target BLER adjustment is used for the UE A, the target BLERs for all slots of the UE A are not necessarily the same, e.g., the target BLER for a slot 0 may be 20% and the target BLER for a slot 1 may be 30%.

After determining the target BLER adjustment method for the target UE, for example, the target BLER for the target UE may be determined using the AI method based on the measurement information of the service cell (e.g., RSRP, CQI, RI, PMI), the measurement information of the neighbor cell (e.g., RSRP), and the PRB loading information of the neighbor cell.

After determining the target BLER, the RIC may transmit the determined target BLER to the base station. It is noted that although the target BLER adaptation is performed by the RIC as illustrated in FIG. 21, in an embodiment, the target BLER adaptation may also be performed by the base station, for example, if the base station has sufficient an AI computation capability.

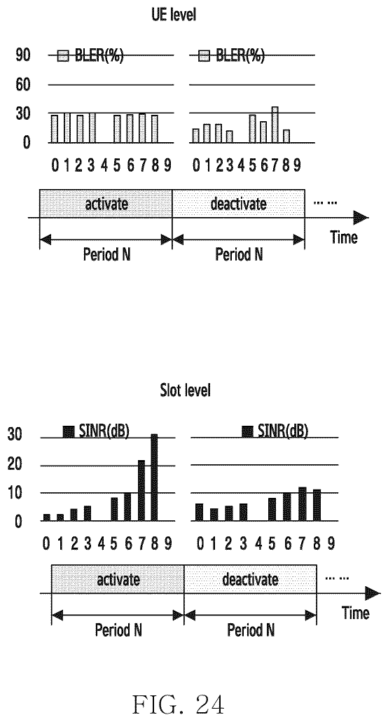

At step 3, the base station may perform channel state self-checking (i.e., checking the channel fluctuation state as mentioned above) to determine whether to continue using the current target BLER to deal with the anomalous situation where the actual neighboring cell traffic does not match the acquired traffic. As shown in FIG. 24, if the target BLER adjustment method for the target UE is the UE-level target BLER adjustment method, the channel fluctuation state may be periodically acquired based on the actual BLER difference between different slots of the target UE, and whether the state of the signal state acquisition period is an activate state or a deactivate state may be determined based on the acquired channel fluctuation state. If the target BLER adjustment method for the target UE is the slot-level target BLER adjustment method, the channel fluctuation state may be periodically acquired based on the signal-to-interference noise ratio (SINR) difference between different slots of the target UE, and whether the state of the signal state acquisition period is an activate state or a deactivate state may be determined based on the acquired channel fluctuation state. If it is an activate state, it is determined to continue using the current target BLER, and if it is a deactivate state, the default fixed target BLER is used.

Whenever the target BLER is adjusted, the base station may, at step 4, perform target BLER update and compensation, i.e., perform SINR compensation based on the target BLER after adjusting and the target BLER before adjusting. Finally, the base station may determine a Modulation and Coding Scheme (MCS) based on the adjusted target BLER, transmit data, e.g., scheduling information, to the UE in accordance with the determined MCS, and the UE performs data detection.

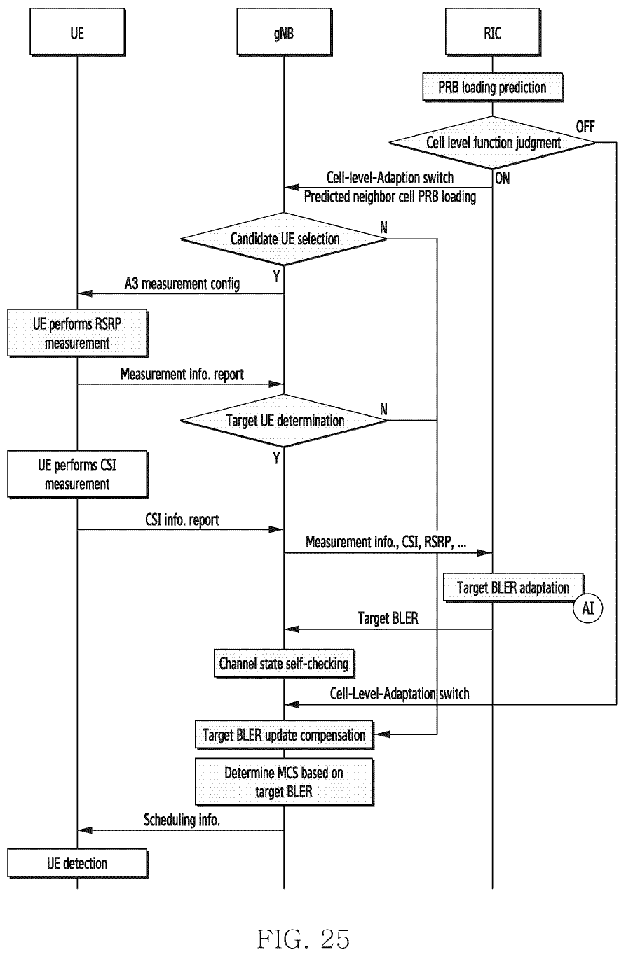

In order to further improve the transmission performance and reduce the computational complexity of the base station, in various embodiments of the present disclosure, the traffic prediction of the interference cell of the UE and the cell-level target BLER adaptive switch control may be performed by the RIC. For example, as shown in FIG. 25, the traffic prediction may be performed by the RIC, e.g., PRB loading prediction may be performed based on traffic information reported by each interference cell. Subsequently, cell-level functional adjustment is performed (i.e., cell-level target BLER adaptive switch judgment is performed) by the RIC based on the predicted traffic. Only when the cell-level target BLER adaptive switch is ON, the RIC transmits the predicted traffic information (e.g., predicted neighbor cell PRB load) of the interference cell to the base station, so that the base station may select the candidate UE accordingly. The other operations in FIG. 25 are the same as those already described in FIG. 21, and will not be repeated here.

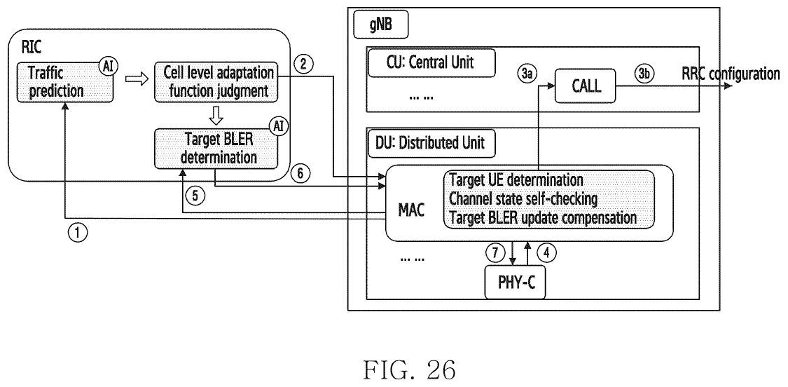

In the above, it is mentioned that the target BLER adjustment may be realized by the base station and the RIC together. For ease of understanding, an example deployment scheme for realizing the concept of the present disclosure is briefly described below in connection with FIG. 26.

For example, in the example of FIG. 26, the AI module and the cell-level target BLER adaptive switch judgment of the present invention may be deployed on the RIC side, and the other functions are deployed in a Medium Access Control (MAC) module of a Distributed Unit (DU) of the base station, and, in the example of FIG. 26, the interference cell is a neighboring cell, as an example.

As shown in FIG. 26, the adaptive adjustment of the target BLER may be realized by the following steps.
Step 1: The MAC collects historical traffic information of a cell and periodically reports it to the RIC.
Step 2: The RIC predicts traffic and judges a cell-level adaptive function switch based on the historical traffic information reported by the MAC, and transmits the judgment result and the predicted traffic information to the MAC.
Steps 3a and 3b: If the cell-level adaptive function switch is set to “ON”, the MAC determines a candidate UE, configures RRC for the candidate user, and triggers it to perform neighbor cell measurement.
Step 4: The MAC determines a target UE based on measurement information of the neighboring cell reported by the candidate UE.
Step 5: The MAC reports the determination result of the target UE and the measurement information (such as CSI) of the neighboring cell of the target UE to the RIC.
Step 6: The RIC performs adaptive target BLER determination and transmits the determination result to the MAC.
Step 7: The MAC performs channel state self-checking and target BLER update and compensation (i.e., performs SINR compensation) and controls the physical layer (Physical Layer-Control, PHY-C) for corresponding data transmission.

The methods according to various embodiments of the present disclosure have been described above. For example, various embodiments of the present disclosure may be applied to at least the following scenarios:
Scenario 1: neighbor cell interference of a service cell and neighbor cell traffics corresponding to different slot indexes of a service cell vary greatly. In this scenario, the neighbor cell interference fluctuates greatly and interference fluctuations corresponding to different slot indexes are different. If a traditional scheme is adopted, a fixed target BLER scheme is applied to all UEs under the service cell, which cannot adapt to the neighbor cell interference fluctuation, resulting in limited user transmission performance and seriously affecting the user experience. For this scenario, the “slot-level” adaptive target BLER adjustment in the present disclosure may be adopted, and different target BLERs are adopted for different slots of the target UE, which can, for example, accurately match the interference fluctuations of different slots in the neighbor cell, effectively improve the transmission performance of the target UE, and also improve the average performance of the cell to a certain extent. Simulation results show that the average performance of the target user in the cell is improved by about 25%, and the average performance of all UEs in the cell is also improved by about 6%.
Scenario 2: neighbor cell interference of the serving cell and neighbor cell traffic of the serving cell is medium and neighbor cell traffics corresponding to different slot indexes do not vary greatly. In this scenario, the neighbor cell interference fluctuation is large, but the difference of interference fluctuations corresponding to different slot indexes is small. If a traditional scheme is adopted, the same target BLER scheme is applied to all UEs under the service cell, which cannot adapt to the neighbor cell interference fluctuation situation, resulting in limited user transmission performance and seriously affecting the user experience. For this scenario, the “user-level” adaptive target BLER adjustment in the present disclosure may be adopted, where different target BLERs are adopted for the target UEs to accurately match the neighbor cell interference fluctuations and allow the target UEs to quickly converge to the adaptive target BLER, which, for example, effectively improves the transmission performance of the target user and also improves the average performance of the cell to a certain extent. Simulation results show that the average performance of the cell edge user is improved by about 37%, and the average performance of all UEs in the cell is improved by about 11%.

In the following, a network node and a user equipment according to embodiments of the present disclosure are briefly described.

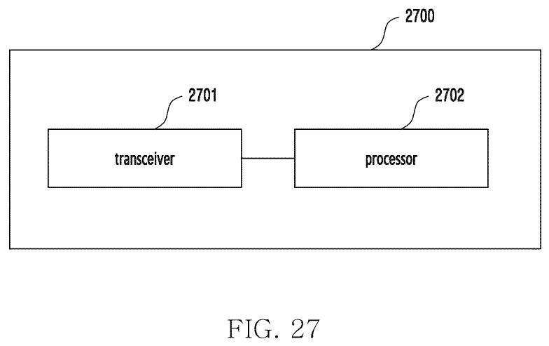

FIG. 27 is a block diagram illustrating an example network node according to various embodiments of the present disclosure. Referring to FIG. 27, the network node 2700 may include a transceiver 2701, and a processor 2702, wherein the processor 2702 is coupled to the transceiver 2701 and configured to perform the methods performed by the network node as described above. According to various embodiments, the network node may include a base station or a RIC, but is not limited thereto.

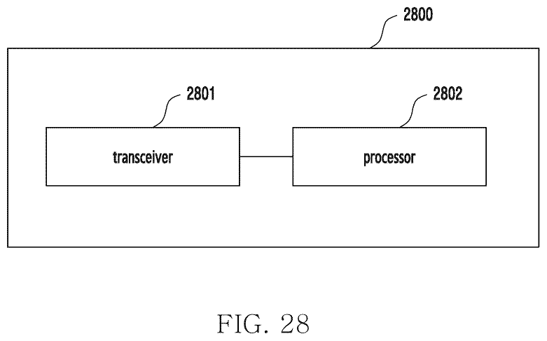

FIG. 28 is a block diagram illustrating an example UE according to various embodiments of the present disclosure. Referring to FIG. 28, the UE 2800 may include a transceiver 2801 and a processor 2802, wherein the processor 2802 is coupled to the transceiver 2801 and configured to perform the methods performed by the UE as described above. The various embodiments of the present disclosure also provide an electronic device including at least one processor, which optionally may also include at least one transceiver and/or at least one memory coupled to the at least one processor, the at least one processor is configured to perform the steps of the methods provided in any optional embodiment of the present disclosure.

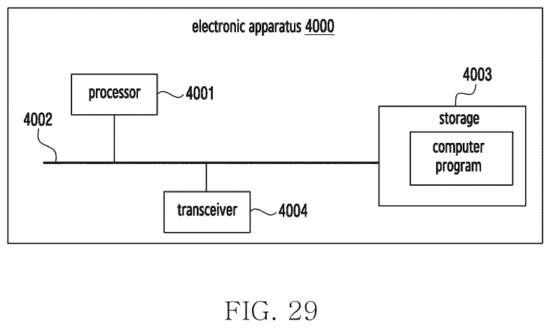

FIG. 29 is a schematic diagram of the structure of an example electronic apparatus to which various embodiments of the present invention is applicable. As shown in FIG. 29, the electronic apparatus 4000 shown in FIG. 29 includes a processor 4001 and a memory 4003. Wherein, the processor 4001 is connected to the memory 4003, such as through a bus 4002. In an embodiment, the electronic apparatus 4000 may further include a transceiver 4004, which can be used for data interaction between this electronic apparatus and other electronic apparatus, such as data transmission and/or data reception. It should be noted that in practical applications, each of the processor 4001, memory 4003, and transceiver 4004 is not limited to one, and the structure of the electronic apparatus 4000 does not constitute a limitation of the various embodiments of the present disclosure. In an embodiment, this electronic apparatus may be a first network node, a second network node, or a third network node.

The processor 4001 can be a CPU (Central Processing Unit), a general-purpose processor, a DSP (Digital Signal Processor), an ASIC (Application Specific Integrated Circuit), an FPGA (Field Programmable Gate Array), or any other programmable logic device, transistor logic device, hardware component, or any combination thereof. It can implement or execute various example logical blocks, modules, and circuits described in conjunction with the content disclosed by the present disclosure. The processor 4001 may also be a combination of computing functions, such as a combination containing one or more microprocessor, a combination of DSP and microprocessor, etc., The processor 4001 may include various processing circuitry (e.g., logic circuits and arithmetic circuits) and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The bus 4002 may include a path to transmit information between the aforementioned components. The bus 4002 can be a PCI (Peripheral Component Interconnect) bus or an EISA (Extended Industry Standard Architecture) bus. The bus 4002 can be classified as address bus, data bus, control bus, etc. For ease of representation, only one thick line is used in FIG. 29, but this does not mean that there is only one bus or one type of bus.

The memory 4003 can be ROM (Read Only Memory) or other types of static storage devices that can store static information and instructions, RAM (Random Access Memory) or other types of dynamic storage devices that can store information and instructions, or EEPROM (Electrically Erasable Programmable Read Only Memory), CD-ROM (Compact Disc Read Only Memory) or other disc storage, optical disc storage (including compressed discs, laser discs, optical discs, digital universal discs, Blu-ray discs, etc.), disk storage media, other magnetic storage devices, or any other media that can be used to carry or store computer programs and can be read by a computer, are not limited herein.

The memory 4003 is used to store computer programs or executable instructions executing the various embodiments of the present disclosure, and the execution is controlled by processor 4001. The processor 4001 is used to execute computer programs or executable instructions stored in memory 4003 to implement the steps shown in the aforementioned method embodiments.

According to an embodiment, a method performed by a network node, may comprise obtaining measurement information of interference cell(s) of at least one UE and/or traffic information of the interference cell(s), adjusting a target block error rate (BLER) for a target UE in the at least one UE according to the measurement information of the interference cell(s) and/or the traffic information of the interference cell(s), and transmitting data to the target UE based on the adjusted target BLER.

According to an embodiment, the adjusting of the target block error rate (BLER) for the target UE in the at least one UE according to the measurement information of the interference cell(s) and/or the traffic information of the interference cell(s) may comprise determining the target UE according to the measurement information of the interference cell(s) and/or the traffic information of the interference cell(s), and adjusting the target BLER for the target UE according to measurement information and/or traffic information of interference cell(s) of the target UE.

According to an embodiment, the method may comprise determining the at least one UE from candidate UEs according to measurement information of a serving cell of each of the candidate UEs, and transmitting, to the at least one UE, a signaling for configuring the at least one UE to perform an interference cell measurement. The measurement information of the interference cell(s) of the at least one UE is obtained by the at least one UE through performing the interference cell measurement based on the signaling.

According to an embodiment, the determining of the at least one UE from the candidate UEs according to the measurement information of the serving cell of each of the candidate UEs may comprise determining, as the at least one UE, UE(s) whose measurement information of the serving cell satisfies a specified condition for a specified number of slots among the candidate UEs.

According to an embodiment, the determining of the target UE according to the measurement information of the interference cell(s) and/or the traffic information of the interference cell(s) may comprise obtaining a first classification result by classifying the interference cell(s) according to the measurement information of the interference cell(s), obtaining a second classification result by classifying slots of the UE based on the traffic information of the interference cell(s) and the first classification result, and determining the target UE based on the second classification result.

According to an embodiment, the adjusting of the target block error rate (BLER) for the target UE in the at least one UE according to the measurement information of the interference cell(s) and/or the traffic information of the interference cell(s) comprises at least one of adjusting a target BLER for all slots of the target UE according to measurement information of interference cell(s) of the target UE and average traffic information on all slots of the interference cell(s) of the target UE, adjusting a target BLER for a set slot of the target UE according to the measurement information of the interference cell(s) of the target UE and traffic information on the set slot of the interference cell(s) of the target UE, or determining a target BLER adjustment method for the target UE according to the measurement information and/or traffic information of the interference cell(s) of the target UE, and adjusting the target BLER for the target UE based on the determined target BLER adjustment method.

According to an embodiment, the determining of the target BLER adjustment method for the target UE according to the measurement information and/or the traffic information of the interference cell(s) of the target UE may comprise determining an interference intensity of the interference cell(s) of the target UE according to the measurement information of the interference cell(s) of the target UE, and determining the target BLER adjustment method for the target UE based on the interference intensity and the traffic information of the interference cell(s) of the target UE.

According to an embodiment, the determining of the target BLER adjustment method for the target UE based on the interference intensity and the traffic information of the interference cell(s) of the target UE may comprise determining that the target BLER adjustment method for the target UE is to adjust the target BLER for all slots of the target UE if there exists, for the target UE, an interference cell that satisfies a predefined interference intensity and the traffic of the interference cell that satisfies the predefined interference intensity satisfies a predefined traffic related condition, or, if there exists, for the target UE, no interference cell that satisfies the predefined interference intensity and the traffic for interference cells of the target UE all satisfies the predefined traffic related condition; otherwise, determining that the target BLER adjustment method for the target UE is to adjust the target BLER for the set slot of the target UE.

According to an embodiment, the adjusting of the target BLER for all slots of the target UE according to the measurement information of the interference cell(s) of the target UE and the average traffic information on all slots of the interference cell(s) of the target UE may comprise predicting a target BLER for all slots of the target UE using a pre-trained artificial intelligence model according to the measurement information of the interference cell(s) of the target UE and the average traffic information on all slots of the interference cell(s) of the target UE, and adjusting the target BLER for all slots of the target UE based on the predicted target BLER, or determining a target BLER for all slots of the target UE using a pre-established mapping relationship between an interference fluctuation level and the target BLER according to the measurement information of the interference cell(s) of the target UE and the average traffic information on all slots of the interference cell(s) of the target UE, and adjusting the target BLER for all slots for the target UE based on the determined target BLER, wherein the interference fluctuation level is determined based on the average traffic information.

According to an embodiment, the adjusting of the target BLER for the set slot of the target UE according to the measurement information of the interference cell(s) of the target UE and the traffic information on the set slot of the interference cell(s) of the target UE may comprise predicting a target BLER for the set slot of the target UE using a pre-trained artificial intelligence model according to the measurement information of the interference cell(s) of the target UE and the traffic information on the set slot of the interference cell(s) of the target UE, and adjusting the target BLER for the set slot of the target UE based on the predicted target BLER, or determining a target BLER for the set slot of the target UE using a pre-established mapping relationship between an interference fluctuation level and the target BLER according to the measurement information of the interference cell(s) of the target UE and the traffic information on the set slot of the interference cell(s) of the target UE, and adjusting the target BLER for the set slot of the target UE based on the determined target BLER, wherein the interference fluctuation level is determined based on the traffic information on the set slot.

According to an embodiment, the method may comprise obtaining a channel fluctuation state for the target UE, and determining whether to continue using a current target BLER according to the channel fluctuation state.

According to an embodiment, the obtaining of the channel fluctuation state for the target UE may comprise obtaining the channel fluctuation state according to a channel difference between different slots of the target UE, wherein the channel difference between different slots of the target UE comprises a difference in actual BLERs between different slots of the target UE, or a difference in signal-to-interference noise ratios (SINRs) between different slots of the target UE.

According to an embodiment, the determining of whether to continue using the current target BLER according to the channel fluctuation state may comprise marking a channel fluctuation state acquisition period as an activated state or a deactivated state according to the channel fluctuation state, if the channel fluctuation state acquisition period is marked as the activated state, continuing using the current target BLER during the channel fluctuation state acquisition period, and if the channel fluctuation status acquisition period is marked as the deactivated state, using a default fixed target BLER during the channel fluctuation state acquisition period.

According to an embodiment, a method performed by a user equipment (UE), may comprise reporting, to a base station, measurement information of interference cell(s) of the UE, and receiving, from the base station, data transmitted based on a target block error rate (BLER) for the UE, wherein the target BLER is adjusted according to the measurement information of the interference cell(s) and/or traffic information of the interference cell(s).

According to an embodiment, the method may comprise receiving, from the base station, a signaling for configuring the UE to perform an interference cell measurement. The measurement information of the interference cell(s) is obtained by the UE by performing the interference cell measurement based on the signaling.

According to an embodiment, the method may comprise transmitting, to the base station, measurement information of a serving cell of the UE, wherein the measurement information of the serving cell is used by the base station to determine whether to transmit the signaling to the UE.

According to an embodiment, a network node may comprise a transceiver, a processor coupled to the transceiver. The processor may be configured to obtain measurement information of interference cell(s) of at least one UE and/or traffic information of the interference cell(s), adjust a target block error rate (BLER) for a target UE in the at least one UE according to the measurement information of the interference cell(s) and/or the traffic information of the interference cell(s), and transmit data to the target UE based on the adjusted target BLER.

According to an embodiment, the network node comprises a base station or a radio access network intelligent controller (RIC).

According to an embodiment, a user equipment may comprise a transceiver and a processor coupled to the transceiver. The processor may be configured to report, to a base station, measurement information of interference cell(s) of the UE, and receive, from the base station, data transmitted based on a target block error rate (BLER) for the UE, wherein the target BLER is adjusted according to the measurement information of the interference cell(s) and/or traffic information of the interference cell(s).

According to an embodiment, a non-transitory computer readable storage medium may store instructions. The instructions, when executed by at least one processor of a network node, may cause the at least one processor to control the network node to obtain measurement information of interference cell(s) of at least one UE and/or traffic information of the interference cell(s), adjust a target block error rate (BLER) for a target UE in the at least one UE according to the measurement information of the interference cell(s) and/or the traffic information of the interference cell(s), and transmit data to the target UE based on the adjusted target BLER.

According to an embodiment, a network node may comprise a transceiver, memory including one or more storage mediums storing instructions, and at least one processor comprising processing circuitry. The instructions that, when executed by the at least one processor individually or collectively, may cause the network node to obtain measurement information of an interference cell of at least one UE and/or traffic information of the interference cell, adjust a target block error rate (BLER) for a target UE in the at least one UE according to the measurement information of the interference cell and/or the traffic information of the interference cell, and transmit data to the target UE based on the adjusted target BLER.

According to an embodiment, the network node may comprise a base station or a radio access network intelligent controller (RIC).

According to an embodiment, a user equipment (UE) may comprise a transceiver, memory including one or more storage mediums storing instructions, and at least one processor comprising processing circuitry. The instructions, when executed by the at least one processor individually or collectively, may cause the UE to report, to a base station, measurement information of an interference cell of the UE, and receive, from the base station, data transmitted based on a target block error rate (BLER) for the UE, wherein the target BLER is adjusted according to the measurement information of the interference cell and/or traffic information of the interference cell.

According to an embodiment, a non-transitory computer readable storage medium may store instructions. The instructions, when executed by at least one processor of a network node, may cause the at least one processor to control the network node to obtain measurement information of interference cell of at least one UE and/or traffic information of the interference cell, adjust a target block error rate (BLER) for a target UE in the at least one UE according to the measurement information of the interference cell and/or the traffic information of the interference cell, and transmit data to the target UE based on the adjusted target BLER.

In an embodiment of the present disclosure, a computer-readable storage medium storing computer programs or instructions may be provided, wherein the computer programs or instructions, when being executed by at least one processor, may execute or implement the steps and corresponding contents of the aforementioned method embodiments.

In an embodiment of the present disclosure, a computer program product may be provided, which includes computer programs, that when being executed by a processor, may execute or implement the steps and corresponding contents of the aforementioned method embodiments.

The terms “first”, “second”, “third”, “fourth”, “1”, “2” and the like (if exists) in the description and claims of the present disclosure and the above drawings are used to distinguish similar objects, and need not be used to describe a specific order or sequence. It should be understood that data used as such may be interchanged in appropriate situations, so that the embodiments of the present disclosure described here may be implemented in an order other than the illustration or text description.

It should be understood that although each operation step is indicated by arrows in the flowcharts of the embodiments of the present disclosure, an implementation order of these steps is not limited to an order indicated by the arrows. Unless explicitly stated herein, in some implementation scenarios of the various embodiments of the present disclosure, the implementation steps in the flowcharts may be executed in other orders according to requirements. In addition, some or all of the steps in each flowchart may include a plurality of sub steps or stages, based on an actual implementation scenario. Some or all of these sub steps or stages may be executed at the same time, and each sub step or stage in these sub steps or stages may also be executed at different times. In scenarios with different execution times, an execution order of these sub steps or stages may be flexibly configured according to requirements, which is not limited by the embodiment of the present disclosure.

The above description and drawings are provided as examples only to assist readers in understanding the present disclosure. They are not intended and should not be interpreted as limiting the scope of the present disclosure in any way. Although certain embodiments and examples have been provided, based on the content disclosed herein, it is apparent to those skilled in the art that changes can be made to the shown embodiments and examples without departing from the scope of the present disclosure. Adopting other similar implementations based on the technical ideas of the present disclosure also fall within the scope of protection of embodiments of the disclosed disclosure.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

No claim element is to be construed under the provisions of 35 U.S.C. § 112, sixth paragraph, unless the element is expressly recited using the phrase “means for” or “means.”

What is claimed is:

1. A method performed by a network node, the method comprising:
obtaining measurement information of an interference cell of at least one UE and/or traffic information of the interference cell;
adjusting a target block error rate (BLER) for a target UE in the at least one UE according to the measurement information of the interference cell and/or the traffic information of the interference cell; and
transmitting data to the target UE based on the adjusted target BLER.

2. The method according to claim 1, wherein the adjusting of the target block error rate (BLER) for the target UE in the at least one UE according to the measurement information of the interference cell and/or the traffic information of the interference cell comprises:
determining the target UE according to the measurement information of the interference cell and/or the traffic information of the interference cell; and
adjusting the target BLER for the target UE according to measurement information and/or traffic information of interference cell of the target UE.

3. The method according to claim 1, further comprising:
determining the at least one UE from candidate UEs according to measurement information of a serving cell of each of the candidate UEs; and
transmitting, to the at least one UE, a signaling for configuring the at least one UE to perform an interference cell measurement,
wherein the measurement information of the interference cell of the at least one UE is obtained by the at least one UE through performing the interference cell measurement based on the signaling.

4. The method according to claim 3, wherein the determining of the at least one UE from the candidate UEs according to the measurement information of the serving cell of each of the candidate UEs comprises:
determining, as the at least one UE, UE(s) whose measurement information of the serving cell satisfies a specified condition for a specified number of slots among the candidate UEs.

5. The method according to claim 2, wherein the determining of the target UE according to the measurement information of the interference cell and/or the traffic information of the interference cell comprises:
obtaining a first classification result by classifying the interference cell according to the measurement information of the interference cell;
obtaining a second classification result by classifying slots of the UE based on the traffic information of the interference cell and the first classification result; and
determining the target UE based on the second classification result.

6. The method according to claim 1, wherein the adjusting of the target block error rate (BLER) for the target UE in the at least one UE according to the measurement information of the interference cell and/or the traffic information of the interference cell comprises at least one of:
adjusting a target BLER for all slots of the target UE according to measurement information of interference cell of the target UE and average traffic information on all slots of the interference cell of the target UE;
adjusting a target BLER for a set slot of the target UE according to the measurement information of the interference cell of the target UE and traffic information on the set slot of the interference cell of the target UE; or
determining a target BLER adjustment method for the target UE according to the measurement information and/or traffic information of the interference cell of the target UE, and adjusting the target BLER for the target UE based on the determined target BLER adjustment method.

7. The method according to claim 6, wherein the determining of the target BLER adjustment method for the target UE according to the measurement information and/or the traffic information of the interference cell of the target UE comprises:
determining an interference intensity of the interference cell of the target UE according to the measurement information of the interference cell of the target UE; and
determining the target BLER adjustment method for the target UE based on the interference intensity and the traffic information of the interference cell of the target UE.

8. The method according to claim 7, wherein the determining of the target BLER adjustment method for the target UE based on the interference intensity and the traffic information of the interference cell of the target UE comprises:
determining that the target BLER adjustment method for the target UE is to adjust the target BLER for all slots of the target UE if there exists, for the target UE, an interference cell that satisfies a predefined interference intensity and the traffic of the interference cell that satisfies the predefined interference intensity satisfies a predefined traffic related condition, or, if there exists, for the target UE, no interference cell that satisfies the predefined interference intensity and the traffic for interference cells of the target UE all satisfies the predefined traffic related condition; otherwise, determining that the target BLER adjustment method for the target UE is to adjust the target BLER for the set slot of the target UE.

9. The method according to claim 6, wherein the adjusting of the target BLER for all slots of the target UE according to the measurement information of the interference cell of the target UE and the average traffic information on all slots of the interference cell of the target UE comprises:
predicting a target BLER for all slots of the target UE using a pre-trained artificial intelligence model according to the measurement information of the interference cell of the target UE and the average traffic information on all slots of the interference cell of the target UE, and adjusting the target BLER for all slots of the target UE based on the predicted target BLER; or
determining a target BLER for all slots of the target UE using a pre-established mapping relationship between an interference fluctuation level and the target BLER according to the measurement information of the interference cell of the target UE and the average traffic information on all slots of the interference cell of the target UE, and adjusting the target BLER for all slots for the target UE based on the determined target BLER, wherein the interference fluctuation level is determined based on the average traffic information.

10. The method according to claim 6, wherein the adjusting of the target BLER for the set slot of the target UE according to the measurement information of the interference cell of the target UE and the traffic information on the set slot of the interference cell of the target UE comprises:
predicting a target BLER for the set slot of the target UE using a pre-trained artificial intelligence model according to the measurement information of the interference cell of the target UE and the traffic information on the set slot of the interference cell of the target UE, and adjusting the target BLER for the set slot of the target UE based on the predicted target BLER; or
determining a target BLER for the set slot of the target UE using a pre-established mapping relationship between an interference fluctuation level and the target BLER according to the measurement information of the interference cell of the target UE and the traffic information on the set slot of the interference cell of the target UE, and adjusting the target BLER for the set slot of the target UE based on the determined target BLER, wherein the interference fluctuation level is determined based on the traffic information on the set slot.

11. The method according to claim 1, further comprising:
obtaining a channel fluctuation state for the target UE; and
determining whether to continue using a current target BLER according to the channel fluctuation state.

12. The method according to claim 11, wherein the obtaining of the channel fluctuation state for the target UE comprises:
obtaining the channel fluctuation state according to a channel difference between different slots of the target UE, wherein the channel difference between different slots of the target UE comprises a difference in actual BLERs between different slots of the target UE, or a difference in signal-to-interference noise ratios (SINRs) between different slots of the target UE.

13. The method according to claim 12, wherein the determining of whether to continue using the current target BLER according to the channel fluctuation state comprises:
marking a channel fluctuation state acquisition period as an activated state or a deactivated state according to the channel fluctuation state;
if the channel fluctuation state acquisition period is marked as the activated state, continuing using the current target BLER during the channel fluctuation state acquisition period; and
if the channel fluctuation status acquisition period is marked as the deactivated state, using a default fixed target BLER during the channel fluctuation state acquisition period.

14. A method performed by a user equipment (UE), the method comprising:
reporting, to a base station, measurement information of interference cell of the UE; and
receiving, from the base station, data transmitted based on a target block error rate (BLER) for the UE, wherein the target BLER is adjusted according to the measurement information of the interference cell and/or traffic information of the interference cell.

15. The method according to claim 14, further comprising:
receiving, from the base station, a signaling for configuring the UE to perform an interference cell measurement,
wherein the measurement information of the interference cell is obtained by the UE by performing the interference cell measurement based on the signaling.

16. The method according to claim 15, further comprising:
transmitting, to the base station, measurement information of a serving cell of the UE, wherein the measurement information of the serving cell is used by the base station to determine whether to transmit the signaling to the UE.

17. A network node comprising:
a transceiver;
memory including one or more storage mediums storing instructions, and
at least one processor comprising processing circuitry;
wherein the instructions that, when executed by the at least one processor individually or collectively, cause the network node to:
obtain measurement information of an interference cell of at least one UE and/or traffic information of the interference cell;
adjust a target block error rate (BLER) for a target UE in the at least one UE according to the measurement information of the interference cell and/or the traffic information of the interference cell; and
transmit data to the target UE based on the adjusted target BLER.

18. The network node according to claim 17, wherein the network node comprises a base station or a radio access network intelligent controller (RIC).

19. A user equipment (UE) comprising:
a transceiver;
memory including one or more storage mediums storing instructions, and
at least one processor comprising processing circuitry;
wherein the instructions that, when executed by the at least one processor individually or collectively, cause the UE to:
report, to a base station, measurement information of an interference cell of the UE; and
receive, from the base station, data transmitted based on a target block error rate (BLER) for the UE, wherein the target BLER is adjusted according to the measurement information of the interference cell and/or traffic information of the interference cell.

20. A non-transitory computer readable storage medium storing instructions that, when executed by at least one processor of a network node, cause the at least one processor to control the network node to:
obtain measurement information of interference cell of at least one UE and/or traffic information of the interference cell;
adjust a target block error rate (BLER) for a target UE in the at least one UE according to the measurement information of the interference cell and/or the traffic information of the interference cell; and
transmit data to the target UE based on the adjusted target BLER.
